(19) United States
(12) Patent Application Publication
(10) Pub. No.: US 2001/0028710 A1
(43) Pub. Date: Oct. 11, 2001

(54) Exchange system, telephone exchange apparatus, and computer apparatus

(75) Inventors: Yasumasa Sasaki, Tachikawa-shi (JP); Seiichi Yamamoto, Sagamihara-shi (JP); Takahiro Izawa, Hachioji-shi (JP); Toru Iida, Hachioji-shi (JP); Katsunori Utsumi, Hino-shi (JP); Shingo Kimura, Ome-shi (JP); Shuiji Fujitsuka, Hino-shi (JP); Emi Senga, Hachioji-shi (JP); Yoshimitsu Ebisawa, Musashino-shi (JP); Hiroaki Nagashima, Sagamihara-shi (JP); Tsutomu Shibata, Hino-shi (JP); Shigeru Fukazawa, Hachioji-shi (JP); Satoshi Nishiyama, Hino-shi (JP); Fumio Shibasaki, Sagamihara-shi (JP); Kenichi Kitazawa, Hino-shi (JP); Seiji Tani, Fussa-shi (JP); Yoshihiro Kawauchi, Hachioji-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 09/811,621

(22) Filed: Mar. 20, 2001

(30) Foreign Application Priority Data
Mar. 21, 2000 (JP) 2000-078417

(51) Int. Cl. H04M 7/00

(52) U.S. Cl. 379/219

(57) ABSTRACT

A personal computer having a speech recognition board and speech synthesis board are connected to a key service unit via a control information communication path and media information communication path. Upon executing an exchange service, it is checked if that exchange service uses media information. When the service uses media information, up and down channels are set on the media information communication path, and voice guidance and a voice dial signal for voice dialing are transferred via these channels, thus making the personal computer execute speech recognition required for voice dialing and a search process of a callee telephone number on the basis of the recognition result.

### CROSS-REFERENCE TO RELATED APPLICATIONS

This application is based upon and claims the benefit of priority from the prior Japanese Patent Application No. 2000-078417, filed Mar. 31, 2000, the entire contents of which are incorporated herein by reference.

### BACKGROUND OF THE INVENTION

The present invention relates to an exchange system in which a computer is connected to a telephone exchange apparatus via a communication path, and the telephone exchange apparatus and computer execute processes associated with exchange services, a telephone exchange apparatus, and a computer apparatus.

In offices and the like, a PBX (Private Branch Exchange) and key telephone key service unit (to be referred to as a key service unit hereinafter) are used as apparatuses for connecting an extension telephone network and public telephone network. These telephone exchange apparatuses (to be referred to as exchange apparatuses hereinafter) are exclusively built to exchange/control a voice line.

By contrast, a personal computer or server is recently provided with a PBX function such as a line exchange function or the like and is used in place of the PBX. Such system is called UnPBX. This system adopts a software configuration in which a PBX application, and CTI (Computer Telephony Integration) applications such as ACD (Automatic Call Distribution), IVR (Interactive Voice Response), and the like are installed on a versatile OS (Operating System). As for hardware, the architecture of a PC/AT compatible personal computer is adopted. For these reasons, the UnPBX can be built at relatively low cost, and its system configuration can be easily changed.

On the other hand, recently, a system in which a personal computer is connected to an exchange apparatus, and executes some of exchange connection processes of the exchange apparatus has also been proposed. In such system, basic processes associated with exchange/connection such as switching between lines, and the like are done within the exchange apparatus, and additional and applied processes associated with exchange/connection of the exchange apparatus are executed by the personal computer.

However, since the conventional UnPBX can accommodate only a small number of lines due to its limited processing performance since it normally uses a personal computer.

In the conventional parallel system, since the exchange apparatus and personal computer are connected via only a control line, processes shared by the personal computer are limited to exchange control of the exchange apparatus, exchange services with recent multimedia techniques cannot be offered, and implementation of such services is demanded.

### BRIEF SUMMARY OF THE INVENTION

It is an object of the present invention to provide an exchange system which can realize an exchange process with high line accommodation capacity, and can execute an exchange service process including multimedia techniques, a telephone exchange apparatus, and a computer apparatus.

In order to achieve the above object, the present invention takes the following means.

That is, the first invention provides an exchange system which comprises a telephone exchange apparatus to which at least one terminal device is connected, and a computer apparatus having a media information processing function, wherein the telephone exchange apparatus and computer apparatus are connected via a media information communication path, and a plurality of media information channels corresponding to the terminal device are set on the media information path. When a service request using the media information is generated, service execution means transmits/receives the media information between the telephone exchange apparatus and computer apparatus via the media information channel on the media information communication path, so that the telephone exchange apparatus and computer apparatus execute the service in collaboration.

Therefore, according to the first invention, upon executing exchange service control with a process of media information such as voice dialing, media information processes can be shared and executed by the computer apparatus independently of the exchange apparatus, and the exchange apparatus and computer apparatus can efficiently execute exchange service control including the media information process in collaboration.

Since the media information channels are permanently assigned in units of terminal devices, even when execution requests of a plurality of exchange services associated with different terminal devices are generated in a given time band, transfer processes of media information associated with these exchange service can be parallelly done, thus efficiently executing the plurality of exchange service control.

In the second invention, a telephone exchange apparatus and computer apparatus are connected via a media information communication path, a plurality of media information channels are set on the media information communication path, and when a service request using media information is generated, an empty media information channel on the media information communication path is selected and the media information is transmitted/received between the telephone exchange apparatus and computer apparatus via the selected media information channel, so that the telephone exchange apparatus and computer apparatus execute the service in collaboration.

Therefore, according to the second invention, the exchange apparatus and computer apparatus can efficiently execute exchange service control including a media information process in collaboration as in the first invention. In addition, since a media information channel is set only when it is required, the use efficiency of a small number of media information channels can be improved when these channels are shared by a large number of terminal devices.

Furthermore, in the third invention, a telephone exchange apparatus and computer apparatus are connected via a control information communication path for transmitting control information, and a media information communication path for transmitting media information using media information channels, and when a service request using media information is generated, service execution means exchanges control information between the telephone exchange apparatus and computer apparatus via the control information communication path, selects an empty media information channel on the media information communication path, and exchanges the media information between the telephone exchange apparatus and computer apparatus via the selected media information channel, so that the telephone exchange apparatus and computer apparatus execute the service.

Therefore, according to the third invention, in addition to the effects obtained by the second invention, since transfer processes of control information and that of media information can be independently and parallelly controlled, the control information and media information can be reliably transferred without influencing each other.

Furthermore, the fourth invention provides an exchange system which comprises a telephone exchange apparatus, a computer apparatus having a media information processing function, and a communication path that connects the telephone exchange apparatus and computer apparatus, wherein when a service request using the media information is generated, it is checked if the service is associated with the computer apparatus, and if it is determined that the service is associated with the computer apparatus, service execution means sends the media information from the telephone exchange apparatus to the computer apparatus via the media information communication path, and the telephone exchange apparatus and computer apparatus execute the service.

According to the fourth invention, since the media information communication path is used only when it is determined that the service is associated with the computer apparatus, the use efficiency of the media information communication path can be improved by preventing wasteful use of the media information communication path.

Moreover, the fifth invention provides an exchange system which comprises a telephone exchange apparatus and a computer apparatus having a media information processing function, wherein a media information communication path for transmitting the media information is provided between the telephone exchange apparatus and computer apparatus, a plurality of media information channels are set on the media information communication path, and when a service request using the media information is generated, service execution means exchanges control information and media information between the exchange apparatus and computer apparatus via the media information channels of the media information communication path, so that the telephone exchange apparatus and computer apparatus execute the service.

Hence, according to the fifth invention, since the media information and control information are transferred using the media information channels set on the media information communication path, the need for a control information communication path can be obviated, and the number of cables that connect the telephone exchange apparatus and computer apparatus can be decreased accordingly, thus simplifying the wiring structure of the system.

In addition, the sixth invention provides an exchange system which comprises a telephone exchange apparatus to which a plurality of terminal devices are connected, and a computer apparatus, wherein the telephone exchange apparatus and computer apparatus are connected via a media information communication path, and when a voice signal is sent from one of the plurality of terminal devices, the voice signal is transferred from the telephone exchange apparatus to the computer apparatus via the media information communication path, speech recognition means of the computer apparatus recognizes the contents of the voice signal, and a dialing process to another terminal device is executed on the basis of the recognition result.

Therefore, according to the sixth invention, upon executing voice dialing, the voice signal of a calling party can be directly transferred from the telephone exchange apparatus to the computer apparatus using the media information communication path, and the computer apparatus can recognize the contents of that signal. For this reason, not only a speech recognition function but also a function of converting a voice signal into a control signal and transferring the control signal to the computer apparatus can be removed from the telephone exchange apparatus, thus reducing the processing load on the telephone exchange apparatus.

As for the dialing process, a dialing control function of the telephone exchange apparatus is used. For this reason, the computer apparatus need not execute a dialing process, and need only transfer the speech recognition result to the telephone exchange apparatus, thus also reducing the processing load on the computer apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram showing a key telephone system as an embodiment of an exchange system according to the present invention;

FIG. 2 is a table showing an example of the correspondence between the callee names and their user telephone numbers;

FIG. 3 is a functional block diagram showing the arrangement of principal part of a key service unit shown in FIG. 1;

FIG. 4 is a functional block diagram showing the arrangement of principal part of a personal computer shown in FIG. 1;

FIG. 5 shows an example of the configuration of a service dependent media information necessity/unnecessity table shown in FIG. 3;

FIG. 6 shows an example of the configuration of a media information communication path empty/busy management table shown in FIG. 3;

FIG. 7 shows an example of the configuration of a terminal correspondence media bus logical channel number table shown in FIG. 3;

FIG. 8 shows an example of the configuration of a media channel logical channel number-time switch output-side channel number correspondence table shown in FIG. 3;

FIG. 9 shows an example of the configuration of a media channel logical channel number-time switch input-side channel number correspondence table shown in FIG. 3;

FIG. 10 is a diagram showing an example of connection operations around a time switch of the key service unit according to the first embodiment;

FIG. 11 is a flow chart showing the channel setup control sequence of a media information communication path and its control contents by a main controller of the key service unit shown in FIG. 3;

FIG. 12 is a schematic functional block diagram showing a key service unit of a key telephone system according to the second embodiment of the present invention;

FIG. 13 shows an example of the configuration of a terminal correspondence media bus logical channel number table shown in FIG. 12;

FIG. 14 is a diagram showing an example of connection operations around a time switch of the key service unit according to the second embodiment;

FIG. 15 is a flow chart showing the channel setup control sequence of a media information communication path and its control contents by a main controller shown in FIG. 12;

FIG. 16 is a schematic functional block diagram showing a key service unit of a key telephone system according to the third embodiment of the present invention;

FIG. 17 shows an example of the configuration of a service dependent media information necessity/unnecessity table shown in FIG. 16;

FIG. 18 shows an example of the configuration of a media bus input-side logical channel empty/busy management table shown in FIG. 16;

FIG. 19 shows an example of the configuration of a media bus output-side logical channel empty/busy management table shown in FIG. 16;

FIG. 20 shows an example of the configuration of a medial channel logical channel number-time switch input/output-side channel number correspondence table shown in FIG. 16;

FIG. 21 is a flow chart showing the channel setup control sequence of a media information communication path and its control contents by a main controller shown in FIG. 16;

FIG. 22 is a diagram showing an example of connection operations around a time switch of the key service unit according to the third embodiment;

FIG. 23 is a schematic functional block diagram showing a key service unit of a key telephone system according to the fourth embodiment of the present invention;

FIG. 24 is a schematic functional block diagram showing a personal computer of the key telephone system according to the fourth embodiment of the present invention;

FIG. 25 shows an example of the configuration of a terminal correspondence media bus logical channel number table shown in FIG. 23;

FIG. 26 shows an example of the configuration of a media information communication channel empty/busy management table shown in FIG. 24;

FIG. 27 is a diagram showing an example of connection operations around a time switch of the key service unit according to the fourth embodiment;

FIG. 28 is a flow chart showing the channel setup control sequence of a media information communication path and its control contents by a main controller shown in FIG. 23;

FIG. 29 is a functional block diagram showing the arrangement of principal part of a key service unit of a key telephone system according to the fifth embodiment of the present invention;

FIG. 30 is a functional block diagram showing the arrangement of principal part of a personal computer of the key telephone system according to the fifth embodiment of the present invention;

FIG. 31 shows an example of the configuration of a service dependent media information necessity/unnecessity table provided to the personal computer shown in FIG. 30;

FIG. 32A is a flow chart showing the channel setup control sequence of a media information communication path and its control contents by main controllers of the key service unit shown in FIG. 29;

FIG. 32B is a flow chart showing the channel setup control sequence of a media information communication path and its control contents by main controllers of the personal computer shown in FIG. 30;

FIG. 33 is a schematic block diagram showing a key telephone system according to the sixth embodiment of the present invention;

FIG. 34 is a functional block diagram showing the arrangement of principal part of a key service unit shown in FIG. 33;

FIG. 35 shows an example of the configuration of a terminal correspondence media bus logical channel number table shown in FIG. 34;

FIG. 36 shows an example of the configuration of a data highway correspondence media bus logical channel number table shown in FIG. 34;

FIG. 37 shows an example of the configuration of a media channel logical channel number-time switch output-side channel number correspondence table shown in FIG. 34;

FIG. 38 shows an example of the configuration of a media channel logical channel number-time switch input-side channel number correspondence table shown in FIG. 34;

FIG. 39 is a functional block diagram showing the arrangement of principal part of a personal computer shown in FIG. 33;

FIG. 40 is a flow chart showing the channel setup control sequence of a media information communication path and its control contents by a main controller of the key service unit shown in FIG. 33; and

FIG. 41 is a diagram showing an example of connection operations around a time switch of the key service unit according to the sixth embodiment.

### DETAILED DESCRIPTION OF THE INVENTION

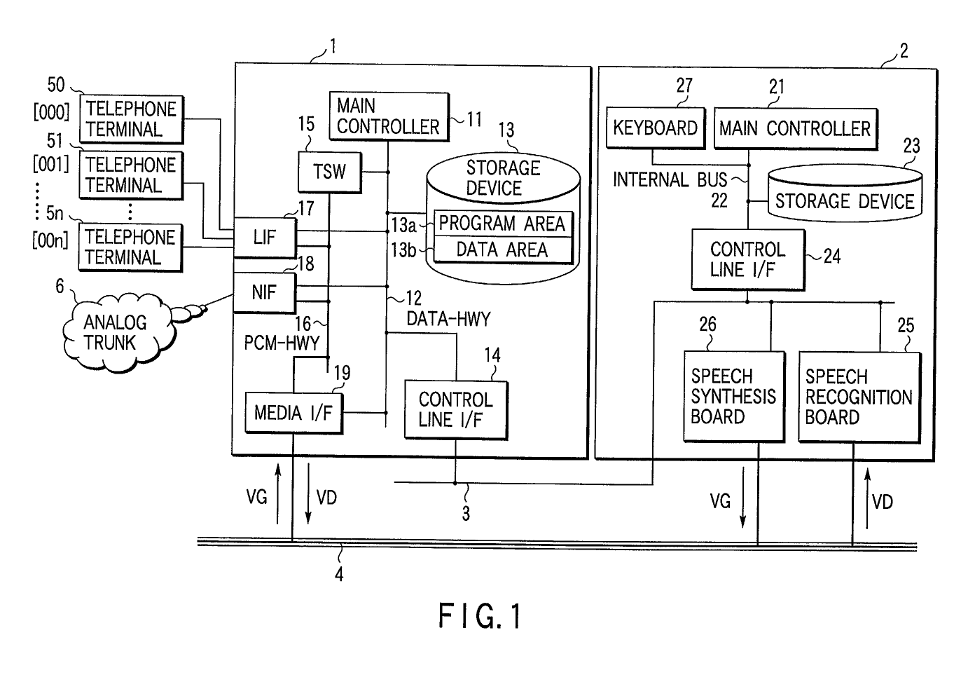

FIG. 1 is a block diagram showing the arrangement of a key telephone system as an embodiment of an exchange system according to the present invention.

The key telephone system comprises a key service unit 1, a plurality of telephone terminals 50 to 5n connected to the key service unit 1 via an extension, and a personal computer 2 which is connected to the key service unit 1 via a control information communication path 3 for transmitting control information and a media information communication path 4 for transmitting media information. Note that media information means audio, image, video signals and the like except for control information, and is particularly required to execute services associated with exchange using the media information communication path 4.

The key service unit 1 has a main controller 11 which comprises a CPU. A data highway (DATA-HWY) 12 for transporting control data including the control information is connected to the main controller 11. A storage device 13, control line interface circuit (control line I/F) 14, time switch (TSW) 15, extension interface circuit (LIF) 17, and analog trunk interface circuit (NIF) 18 are connected to the data highway 12. That is, the storage device 13, control line interface circuit (control line I/F) 14, time switch (TSW) 15, extension interface circuit (LIF) 17, and analog trunk interface circuit (NIF) 18 exchange control data with the main controller 11 via the data highway 12.

The storage device 13 has a program area 13a comprising a ROM, and a data area 13b comprising a RAM. The program area 13a stores programs for systematically controlling the operations of the key service unit 1. The data area 13b stores various kinds of management information required for exchange service processes using media information (to be described later) in addition to various control data required for normal exchange service processes.

The control line I/F 14 executes an interface process associated with exchange of control signals between the data highway 12 and control information communication path 3.

The extension interface circuit 17 executes extension interface processes for the telephone terminals 50 to 5n such as output of incoming call signals to telephone terminals 50 to 5n, detection of outgoing call signals including function number signals (to be described later) from the telephone terminals 50 to 5n, and the like. The analog trunk interface circuit 18 executes trunk interface processes for an analog trunk 6 such as output of an outgoing call signal to the analog trunk 6, detection of an incoming call from the analog trunk 6, and the like.

A media I/F 19 executes an interface process for transferring media information between a PCM highway 16 and the media information communication path 4. Note that the communication scheme on the media information communication path 4 uses H.110, and the media I/F 19 exchanges media information with the media information communication path 4 in accordance with H.110.

The time switch 15 exchanges time slots on the PCM highway 16 in accordance with an instruction from the main controller 11 to connect between the telephone terminals 50 to 5n, between the telephone terminals 50 to 5n and analog trunk 6, and between the telephone terminals 50 to 5n and personal computer 2, thus allowing to transmit audio signals between them.

On the other hand, the personal computer 2 has a main controller 21 which comprises a CPU. A storage device 23 and control line interface circuit (control line I/F) 24 are connected to the main controller 21 via an internal bus 22, and a speech recognition board 25 and speech synthesis board 26 are connected to the main controller 21 via the control line I/F 24.

The main controller 21 controls the storage device 23 and control line interface circuit (control line I/F) 24 via the internal bus 22. Especially, the main controller 21 searches for a telephone number using tables stored in the storage device 23 on the basis of a character string sent from the speech recognition board 25 via the control information communication path 3, and can inform the key service unit 1 of that result, as will be described later.

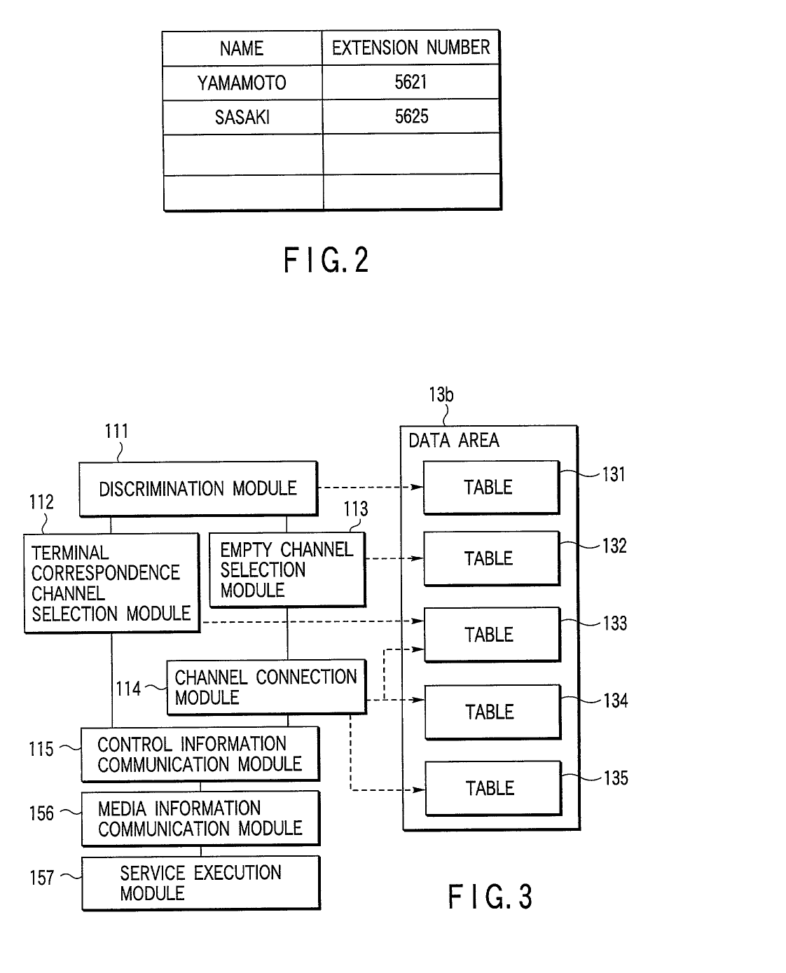

The storage device 23 stores programs and data used to execute processes associated with exchange services, user data pre-set by the user via a keyboard 27, and the like. Especially, the storage device 23 has a table which stores a correspondence between the callee names and telephone numbers of those users shown in FIG. 2. This table is used upon executing a voice dial service.

In the voice dial service, the callee names and telephone numbers are registered in advance in the storage device 23 of the personal computer 2, and when the user inputs a callee name by voice, that input is converted by the speech recognition board 25 into a character string, a corresponding telephone number is read out from the table in the storage device 23, and a call is placed using this telephone number.

The control line I/F 24 executes an interface process associated with exchange of control signals between the internal bus 22 and control information communication path 3.

The speech recognition board 25 has a speech character string conversion table (not shown), receives a voice signal, which is sent from one of the telephone terminals 50 to 5n and indicates a callee name, via the media information communication path 4 upon executing a voice dial service, and converts the waveform of that voice signal into a character string using the aforementioned table. The speech recognition board 25 informs the main controller 21 via the control information communication path 3 and control line I/F 24 of the converted character string.

The speech synthesis board 26 generates a predetermined voice guidance upon executing a voice dial service process, and informs one of the telephone terminals 50 to 5n as a calling telephone terminal of that voice guidance via the media information communication path 4. The contents of the voice guidance include “State callee name aloud.” at the beginning of the voice dial service process, and “Recognition error. State the name slowly again.” when the voice input cannot be recognized.

### First Embodiment

The first embodiment of the present invention with the aforementioned arrangement will be explained below.

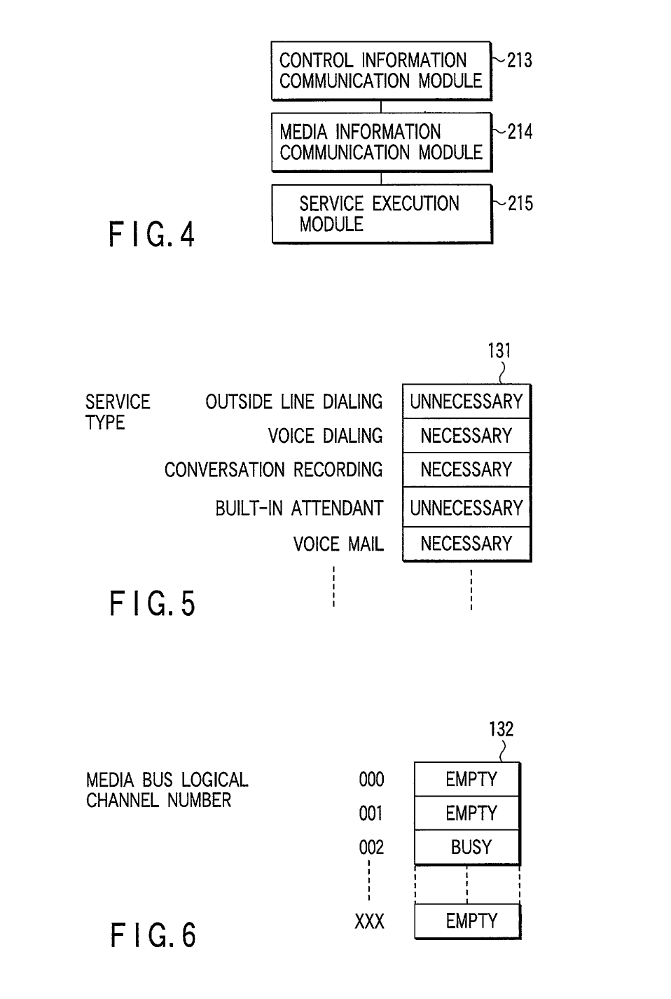

The key service unit 1 stores a plurality of programs for implementing exchange service processes using media information in the program area 13a of the storage device 13. FIG. 3 is a functional block diagram showing the arrangement of principal part of the key service unit 1, and FIG. 4 is a functional block diagram showing the arrangement of principal part of the personal computer 2.

More specifically, on the data area 13b of the storage device 13 a service dependent media information necessity/unnecessity table 131 (to be simply referred to as a table 131 hereinafter), media information communication path empty/busy management table 132 (to be simply referred to as a table 132 hereinafter), terminal correspondence media bus logical channel number table 133 (to be simply referred to as a table 133 hereinafter), media bus logical channel number time switch output-side channel number correspondence table 134 (to be simply referred to as a table 134 hereinafter), and media channel logical channel number-time switch input-side channel number correspondence table 135 (to be simply referred to as a table 135 hereinafter) are prepared.

The table 131 stores information indicating if an exchange service of interest uses media information, in correspondence with the types of exchange services. FIG. 5 shows an example of the storage contents of the table 131.

The table 132 stores the empty/busy states of a plurality of up channels of the media information communication path 4, which go from the personal computer 2 toward the key service unit 1. FIG. 6 shows an example of the storage contents of the table 132.

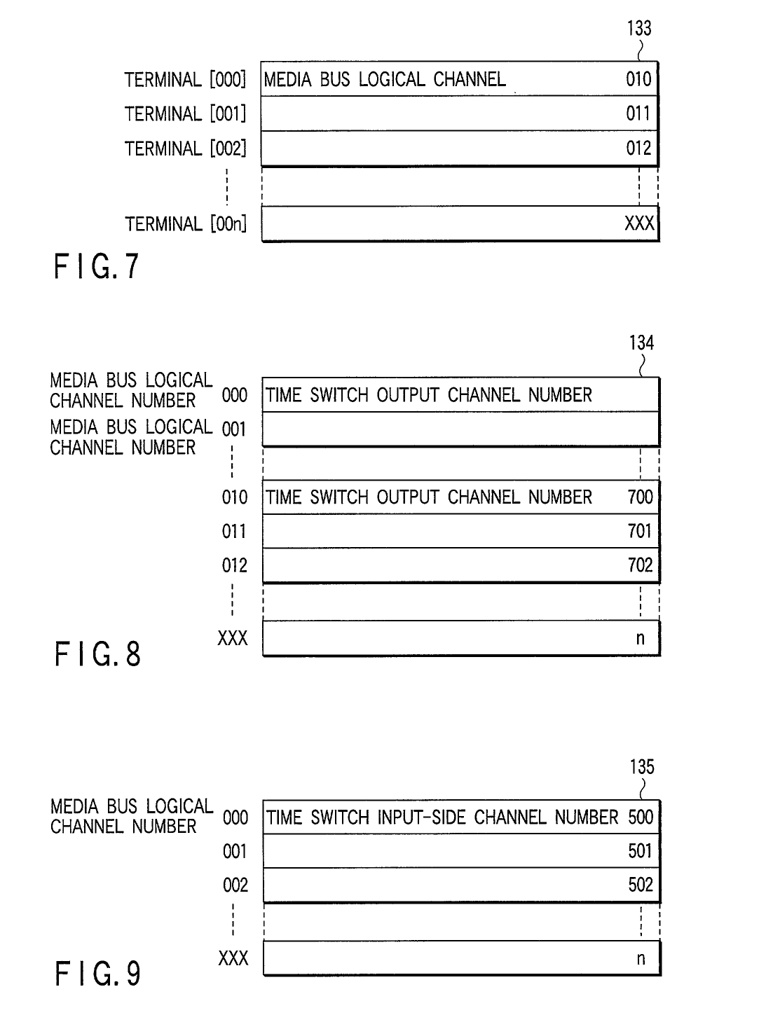

The table 133 stores the numbers (media bus output logical channel numbers) of down channels of the media information communication path 4, which go from the key service unit 1 to the personal computer 2, in correspondence with the telephone terminals 50 to 5n. FIG. 7 shows an example of the storage contents of the table 133.

The table 134 stores the time switch output-side channel numbers of the key service unit 1 in correspondence with the numbers of a plurality of down communication channels of the media information communication path 4, which go from the key service unit 1 to the personal computer 2. FIG. 8 shows an example of the storage contents of the table 134.

The table 135 stores the time switch input-side channel numbers of the key service unit 1 in correspondence with the numbers of a plurality of up communication channels of the media information communication path 4, which go from the personal computer 2 to the key service unit 1. FIG. 9 shows an example of the storage contents of the table 135.

The main controller 11 of the key service unit 1 comprises a discrimination module 111, terminal correspondence channel selection module 112, empty channel selection module 113, channel connection module 114, control information communication module 115, media information communication module 156, and service execution module 157 as functional programs for implementing exchange services using media information.

The discrimination module 111 discriminates based on the contents of the table 131 if an exchange service of interest uses media information, upon activating an exchange service.

The empty channel selection module 113 selects an empty up channel on the basis of the contents of the table 132 when an exchange service that uses an up communication channel of the media information communication path 4 is activated.

The terminal correspondence channel selection module 112 reads out from the table 133 the number of a down communication channel corresponding to the telephone terminal for which an exchange service is executed, when the exchange service using a down communication channel of the media information communication path 4 is activated.

The channel connection module 114 permanently connects time switch input-side channels to which the telephone terminals 50 to 5n are connected, and time-switch output-side channels connected to down channels of the media information communication path 4 by looking up the tables 133 and 134 before the beginning of the operation of the key service unit 1.

The channel connection module 114 connects an up channel of the media information communication path 4 selected by the empty channel selection module 113 to a time switch output-side channel by looking up the table 135 upon executing an exchange service using media information.

The control information communication module 115 sends control information indicating the up channel number of the media information communication path 4 selected by the empty channel selection module 113 and its transmission direction, and control information that designates the down channel number of the media information communication path 4 selected by the terminal correspondence channel selection module 112 and its transmission direction to the control line I/F 14 when an exchange service using the media information communication path 4 is activated.

The media information communication module 156 exchanges media information with the personal computer 2 via the channel set on the media information communication path 4 after the control information is exchanged by the control information communication module 115.

The service execution module 157 executes an exchange service such as voice dialing or the like using the media information communication path 4 on the basis of the media information exchanged by the media information communication module 156.

The control line I/F 14 sends the information to the personal computer 2 via the control information communication path 3.

On the other hand, the main controller 21 of the personal computer 2 comprises a control information communication module 213, media information communication module 214, and service execution module 215.

The control information communication module 213 exchanges control information with the key service unit 1 via the control information communication path 3 when an exchange service using the media information communication path 4 is activated.

The media information communication module 214 exchanges media information with the key service unit 1 via the channels set on the media information communication path 4 on the basis of the exchange result of the control information by the control information communication module 213.

The service execution module 215 executes an exchange service such as voice dialing or the like using the media information communication path 4 on the basis of the media information exchanged by the media information communication module 214.

The operation of the system with the above arrangement will be explained below taking a voice dialing service as an example.

Prior to the beginning of the operation of the system, a maintenance setup terminal (not shown) executes for the storage device 13 of the key service unit 1 a process for permanently assigning down channels of the media information communication path 4, which go from the key service unit 1 to the personal computer 2, to the telephone terminals 50 to 5n.

More specifically, the main controller 11 acquires down channel numbers (media bus output logical channel numbers) of the media information communication path 4 corresponding to the telephone terminals 50 to 5n from the table 133, and obtains time switch output-side channel numbers corresponding to those logical channels from the table 134. Then, the main controller 11 permanently connects the obtained time switch output-side channel and the time switch input-side channels corresponding to the telephone terminals 50 to 5n using the time switch 15.

For example, assume that media bus logical channel numbers “010”, “011”, “102”, . . . are assigned to the telephone terminals 50 to 5n “000”, “001”, “002”, . . . , as shown in FIG. 7, and time switch output-side channel numbers “700”, “701”, “702”, are assigned to these media bus logical channel numbers “010”, “011”, “012”, as shown in FIG. 8.

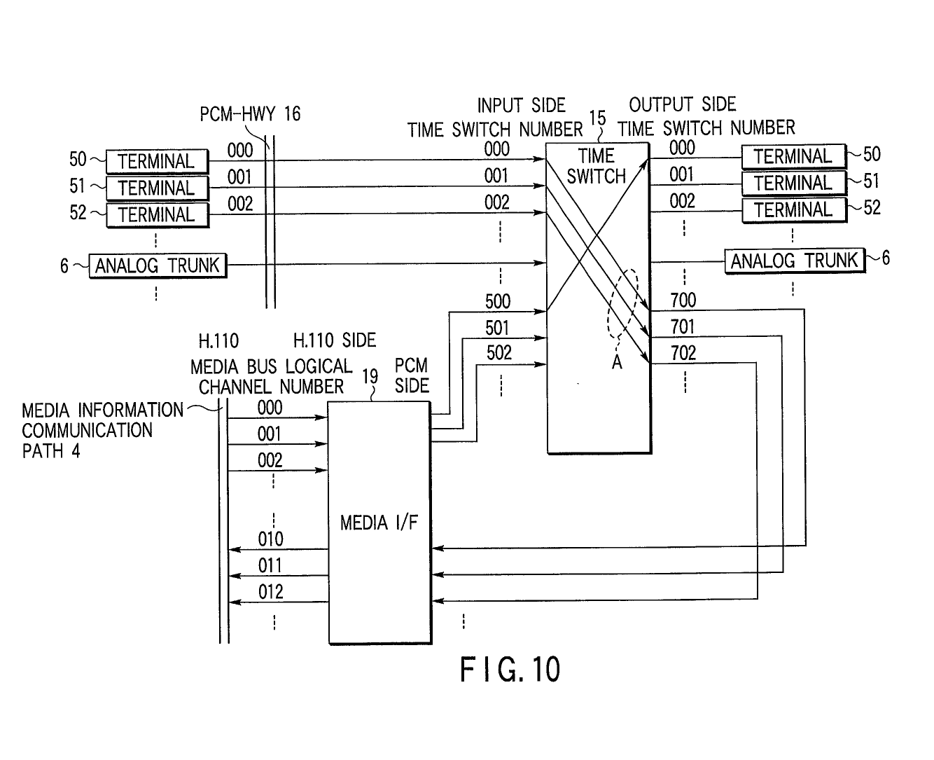

In this case, taking the telephone terminal 50 as an example, media bus logical channel number “010” is obtained from the table 133, and time switch output-side channel number “700” is obtained from table 134 in correspondence with this media bus logical channel number “010”. A time switch output-side channel assigned this number “700” and a time switch input-side channel to which the telephone terminal 50 is connected and which is assigned the number “000” are permanently connected by the time switch 15. Likewise, the remaining telephone terminals 51 to 5n and media bus output logical channels are permanently connected via the time switch 15. A of FIG. 10 indicates such connection state.

As a result of this permanent connection, the telephone terminals 50 to 5n are always connected to the down channels of the media information communication path 4, and the down channels of the media information communication path 4 are ready to always transfer media information output from the telephone terminals 50 to 5n.

Assume that the user of the telephone terminal 50 inputs a function number for executing a voice dialing function using a key-pad or function key (not shown) of the telephone terminal 50 after he or she picks up a handset in this state. A signal indicating the function number (to be referred to a function number signal hereinafter) generated as a result of user's operation is detected by the extension interface circuit 17, and is sent to the main controller 11 via the data highway 12.

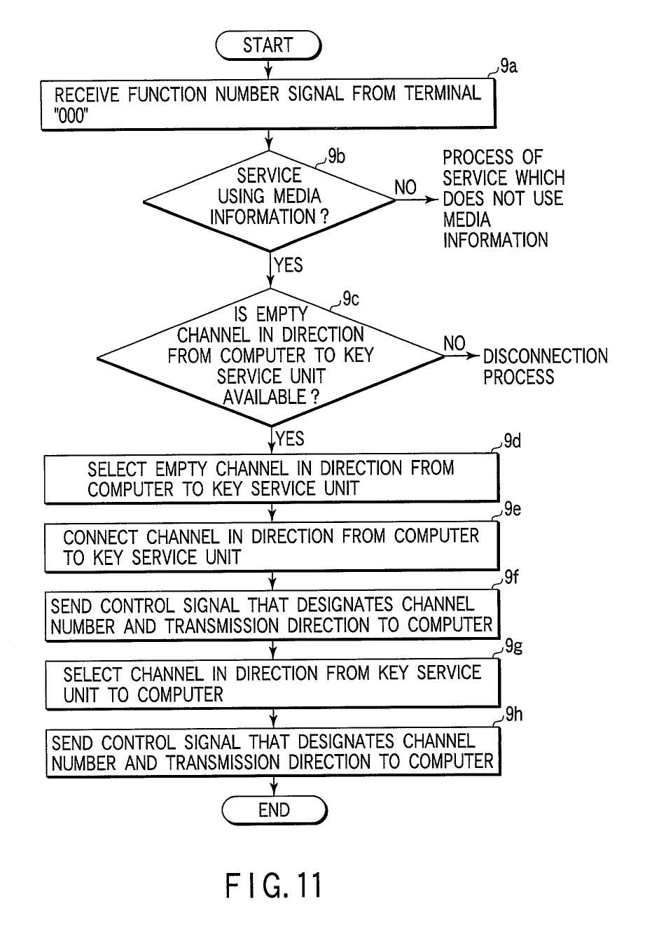

Upon detecting the function number signal in step 9a in FIG. 11, the flow advances to step 9b, and the main controller 11 checks based on the contents of the table 131 if the caller telephone terminal 50 requests an exchange service using media information. If the requested exchange service uses media information, the flow advances to step 9c. If it is determined that the requested exchange service is a normal service that does not use media information, a normal dialing process is executed.

The main controller 11 checks in step 9c based on the contents of the table 132 if an empty channel is available in the up channels of the media information communication path 4. If an empty channel is found, the flow advances to step 9d to select that empty channel, and the selected empty channel is connected to the caller telephone terminal 50 by controlling the time switch 15 in accordance with the contents of the table 135 in step 9e.

For example, assume that media bus logical channel number “000” is selected as an empty channel. Since time switch input-side channel number “1500” is registered in the table 135, as shown in FIG. 9, the main controller 11 controls the media I/F 19 to connect the up channel of media bus logical channel number “000” and time switch input-side channel number “500. The main controller 11 then controls the time switch 15 to connect the time switch input-side channel of number “500”, and the time switch output-side channel of number “000” corresponding to the caller telephone terminal 50, as shown in FIG. 10.

If no empty channel is found in step 9c, a busy tone signal is output to the caller telephone terminal 50, and when the user replaces the handset in response to that tone, a disconnection process is executed.

The main controller 11 generates control information which designates media bus logical channel number “000” and the transmission direction of media information (personal computer 2→key service unit 1), and sends this control information to the personal computer 2 via the control information communication path 3 in step 9f.

Upon receiving this information, the personal computer 2 controls the speech synthesis board 26 to generate voice guidance VG “Input callee name.”, and outputs this voice guidance VG onto the up channel of the designated media bus logical channel number “000”. This voice guidance VG is transferred to the media I/F 19 of the key service unit 1 via the designated up channel “000” of the media information communication path 4, and is then transferred from the media I/F 19 to the caller telephone terminal 50 via the time switch 15.

The main controller 11 of the key service unit 1 selects media bus logical channel number “010”, corresponding to the telephone terminal 50 “number 000” by looking up the table 133 in step 9g. At this time, a down channel from the key service unit 1 to the personal computer 2 has already been permanently assigned. For this reason, a media information transfer path extending from the caller telephone terminal 50 to the personal computer 2 via the time switch 15, media I/F 19, and the down channel of the media information communication path 4 is assured by selecting media bus logical channel number “010”.

The main controller 11 generates control information which designates media bus logical channel number “010” and the transmission direction of media information (key service unit 1→personal computer 2), and sends this control information to the personal computer 2 via the control information communication path 3 in step 9h. Upon receiving this control information, the personal computer 2 connects the down channel of media bus logical channel number “010” to the speech recognition board 25.

Assume that the user of the telephone terminal 50 inputs the callee name “YAMAMOTO” by voice in accordance with the voice guidance VG. A voice signal VD which represents the callee name “YAMAMOTO” is transferred from the telephone terminal 50 to the speech recognition board 25 of the personal computer 2 via the time switch 15, media I/F 19, and down channel “010” of the media information communication path 4. The speech recognition board 25 generates a character string corresponding to the input voice signal VD using a voice-character string conversion table, and sends the character string to the main controller 21. The main controller 21 reads out a corresponding telephone number “1562”, from the storage device 23 on the basis of the received character string “YAMAMOTO”. The main controller 21 then sends this telephone number to the main controller 11 of the key service unit 1 together with a dialing control signal via the control information communication path 3.

Upon receiving the dialing control signal, the main controller 11 of the key service unit 1 detects the telephone number sent together with that control signal, and executes a dialing process to, e.g., a callee telephone terminal 51 on the basis of the detected telephone number. In this manner, voice dialing is executed.

As described above, according to the first embodiment, the personal computer 2 which comprises the speech recognition board 25 and speech synthesis board 26 is connected to the key service unit 1 via the control information communication path 3 and media information communication path 4. Upon executing an exchange service, it is checked if that exchange service uses media information. If the exchange service uses media information, up and down channels are set on the media information communication path 4 to transfer the voice guidance VG and voice dial signal VD for voice dialing, so that the personal computer 2 executes speech recognition required for voice dialing and a search process of the callee telephone number based on the recognition result.

Therefore, the personal computer 2 can share generation of the voice guidance VG, recognition of the voice dial signal VD, and the search process of the callee telephone number required for voice dialing independently of the key service unit 1, thus executing an efficient voice dialing process while reducing the load on the key service unit 1.

Also, in the first embodiment, of the up and down channels to be set on the media information communication path 4, the down channels are permanently set in correspondence with the telephone terminals 50 to 5n prior to the beginning of the operation of the system, and an up channel is set by selecting an empty channel by monitoring the empty channel. Hence, upon executing the voice dial service, an up channel alone need be set, and the control load required for setting channels on the media information communication path 4 can be reduced, thus achieving a high-speed service process.

In addition, the main controller 11 of the key service unit 1 having higher processing performance than the personal computer 2 systematically executes a series of control operations for setting the transfer channels on the media information communication path 4. For this reason, a higher-speed setup process than the personal computer 2 can be done.

Upon generating a dialing request from the telephone terminals 50 to 5n, the key service unit 1 checks if this request uses media information, and executes an exchange service process in accordance with the checking result. For this reason, even when an exchange service process using media information, and a normal exchange service that does not use media information mix, these processes can be efficiently and reliably executed without any confusion.

### Second Embodiment

The second embodiment of the present invention with the aforementioned arrangement will be described below.

In the second embodiment of the present invention, down channels from the key service unit to the personal computer and up channels from the personal computer to the key service unit are permanently set on the media information communication path in advance in correspondence with the telephone terminals, and upon executing an exchange service using media information, a voice signal is transferred using the permanently set channels, thus making the personal computer share the speech processes.

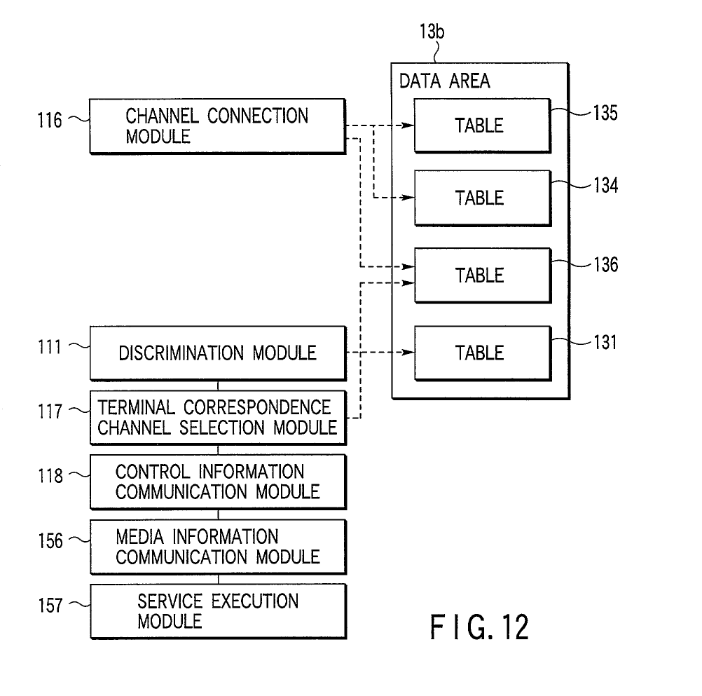

FIG. 12 is a functional block diagram showing the arrangement of principal part of a key telephone system as the second embodiment of an exchange system according to the present invention. Since the hardware arrangement of the key telephone system of this embodiment is the same as that shown in FIG. 1, a detailed description thereof will be omitted. Also, the same reference numerals in FIG. 12 denote the same functional blocks as those in FIG. 3, and a detailed description thereof will be omitted.

On the data area 13b of the storage device 13, a terminal correspondence media bus logical channel number table 136 (to be simply referred to as a table 136 hereinafter) is prepared in addition to the tables 131, 134, and 135.

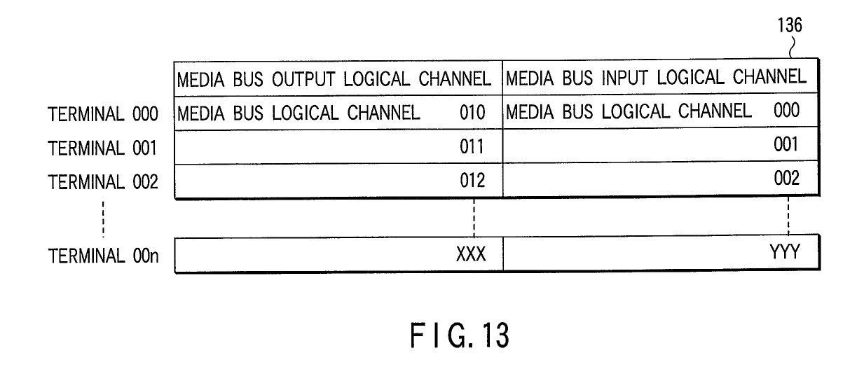

Of these tables, the table 136 stores media bus output logical channel numbers and media bus input logical channel numbers on the media information communication path 4 in correspondence with the telephone terminals 50 to 5n. FIG. 13 shows an example of the storage contents of the table 136.

On the other hand, the main controller 11 of the key service unit 1 comprises a discrimination module 111, channel connection module 116, terminal correspondence channel selection module 117, control information communication module 118, media information communication module 156, and service execution module 157 as new functional programs that implement exchange services using media information.

Of these modules, the terminal correspondence channel selection module 117 reads out from the table 136 a media bus output logical channel number and media bus input logical channel number which are set in advance in correspondence with the corresponding telephone terminal, upon activating an exchange service using media information.

The channel connection module 116 permanently connects time switch input-side channels corresponding to the telephone terminals 50 to 5n and time switch output-side channels corresponding to the media bus output logical channels using the time switch 15 on the basis of the tables 136 and 134, prior to the beginning of the operation of the key telephone system or upon inputting terminal data.

Also, the channel connection module 116 connects the time switch output-side channels corresponding to the telephone terminals 50 to 5n, and time switch input-side channels corresponding to the media bus input logical channels using the time switch 15 on the basis of the tables 136 and 135.

The control information communication module 118 sends control information which designates the media bus output logical channel number and media bus input logical channel number selected by the terminal correspondence channel selection module 117, and the transmission direction to the personal computer 2 via the control information communication path 3, upon activating an exchange service using the media information communication path 4.

The media information communication module 156 exchanges media information with the personal computer 2 via the channels set on the media information communication path 4, after the control information is sent from the control information communication module 118.

The service execution module 157 executes an exchange service such as voice dialing or the like using the media information communication path 4 on the basis of the media information exchanged by the media information communication module 156.

The operation of the system with the above arrangement will be explained below taking a voice dialing service as an example.

Prior to the beginning of the operation of the system, the key service unit 1 executes a process for permanently assigning, to the telephone terminals 50 to 5n, down channels of the media information communication path 4, which go from the key service unit 1 to the personal computer 2, and up channels that go from the personal computer 2 toward the key service unit 1.

More specifically, the main controller 11 acquires from the table 136 down channel numbers (media bus output logical channel numbers) and up channel numbers (media bus input logical channel numbers) of the media information communication path 4, which correspond to the telephone terminals 50 to 5n. The main controller 11 then obtains time switch output-side channel numbers corresponding to the media bus output logical channel numbers from the storage contents of the table 134. The main controller 11 permanently connects the obtained time switch output-side channels and time switch input-side channels corresponding to the telephone terminals 50 to 5n via the time switch 15. Likewise, the main controller 11 obtains time switch input-side channel numbers corresponding to the media bus input logical channel numbers from the storage contents of the table 134. The main controller 11 then controls the time switch 15 to permanently connect the obtained time switch input-side channels and time switch output-side channels corresponding to the telephone terminals 50 to 5n.

For example, assume that media bus logical channel numbers “010”, “011”, “012”, are assigned to the telephone terminals 50 to 5n “000”, “001”, “002”, . . . , as shown in FIG. 13, time switch output-side channel numbers “700”, “701”, “702”, are assigned to these media bus logical channel numbers “010”, “011”, “012”, . . . , as shown in FIG. 8, and time switch input-side channel numbers “500”, “501”, “502”, are assigned to media bus input logical channel numbers “000”, “001”, “002”, . . . , as shown in FIG. 9.

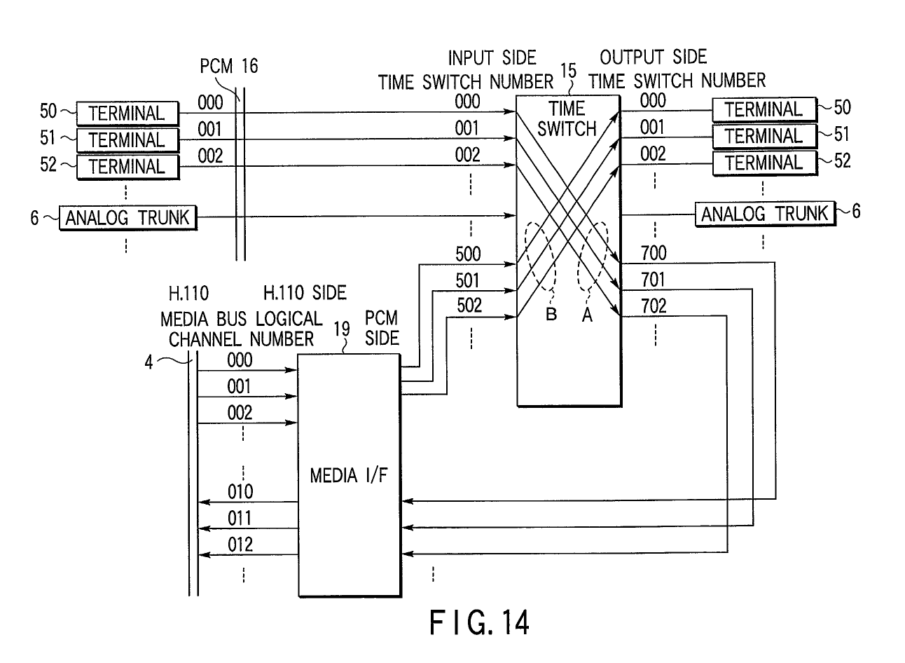

In this case, media bus output logical channel numbers “010”, “011”, “012”, are obtained from the table 136, and time switch output-side channel numbers “700”, “701”, “702”, are obtained from the table 134 in correspondence with the media bus output logical channel numbers “010”, “011”, “012”, . . . . The time switch 15 permanently connects time switch output-side channels with these numbers “700”, “701”, “702”, and time switch input-side channels corresponding to “001”, “002”, assigned to the telephone terminals 50 to 5n, as indicated by A in FIG. 14.

At the same time, media bus input logical channel numbers “000”, “001”, “002”, are obtained from the table 136, and time switch input-side channel numbers “500”, “501”, “502”, are obtained from the table 135 in correspondence with the media bus input logical channel numbers “000”, “001”, “002”, . . . . The time switch 15 permanently connects time switch input-side channels with these numbers “500”, “501”, “502”, and time switch output-side channels corresponding to “001”, “002”, . . . , assigned to the telephone terminals 50 to 5n, as indicated by B in FIG. 14.

As a result of this permanent connection, the telephone terminals 50 to 5n are always connected to the down and up channels of the media information communication path 4, and the telephone terminals 50 to 5n can always transfer media information using the down and up channels of the media information communication path 4.

Assume that the user of the telephone terminal 50 inputs a function number for executing a voice dialing function using a key-pad or function key (not shown) of the telephone terminal 50 after he or she picks up a handset in this state. A function number signal generated as a result of user's operation is detected by the extension interface circuit 17, and is sent to the main controller 11 via the data highway 12.

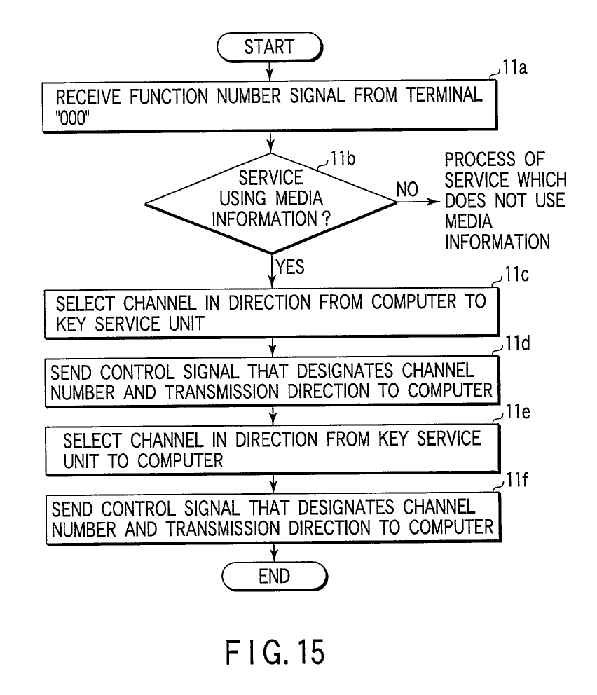

Upon detecting the function number signal in step 11a in FIG. 15, the flow advances to step 11b, and the main controller 11 checks based on the contents of the table 131 if the caller telephone terminal 50 requests an exchange service using media information. If the requested exchange service uses media information, the flow advances to step 11c. If it is determined that the requested exchange service is a normal service that does not use media information, a normal dialing process is executed.

The main controller 11 then selects an up channel of the media information communication path 4, which goes from the personal computer 2 toward the key service unit 1. That is, the main controller 11 selects media bus input logical channel number “000” corresponding to the telephone terminal 50 “number 000” by looking up the table 136 in step 11c. At this time, an up channel from the personal computer 2 to the key service unit 1 has already been permanently assigned, as described above. For this reason, a media information up transfer path extending from the personal computer 2 to the caller telephone terminal 50 via the up channel of the media information communication path 4, media I/F 19, and time switch 15 is assured by selecting media bus logical channel number “010”.

The main controller 11 generates control information which designates media bus input logical channel number “000” and the transmission direction of media information (personal computer 2→key service unit 1), and sends this control information to the personal computer 2 via the control information communication path 3 in step 11d.

Upon receiving this information, the personal computer 2 controls the speech synthesis board 26 to generate voice guidance VG “State callee name aloud.”, and outputs this voice guidance VG onto the up channel of the designated media bus logical channel number “000”. This voice guidance VG is transferred to the media I/F 19 of the key service unit 1 via the designated up channel “000” of the media information communication path 4, and is then transferred from the media I/F 19 to the caller telephone terminal 50 via the time switch 15. Hence, the user of the telephone terminal 50 can know the next operation contents by this voice guidance VG.

The main controller 11 selects the down channel of the media information communication path 4, which goes from the key service unit 1 to the personal computer 2. That is, the main controller 11 selects media bus output logical channel number “010” corresponding to the channel number “000” of the telephone terminal 50 by looking up the terminal correspondence media bus logical channel number table 136 in step 11e. At this time, a down channel from the key service unit 1 to the personal computer 2 has already been permanently assigned, as described above. For this reason, a media information down transfer path extending from the caller telephone terminal 50 to the personal computer 2 via the time switch 15, media I/F 19, and the down channel of the media information communication path 4 is assured by selecting media bus logical channel number “010”.

The main controller 11 generates control information that designates the media bus output logical channel number “010” and the transmission direction of media information (key service unit 1→personal computer 2) and sends it to the personal computer 2 via the control information communication path 3 in step 11f. Upon receiving this information, the personal computer 2 connects the down channel of media bus logical channel number “010” to the speech recognition board 25.

Assume that the user of the telephone terminal 50 inputs the callee name “YAMAMOTO” by voice in accordance with the voice guidance VG. A voice signal VD which represents the callee name “YAMAMOTO” is transferred from the telephone terminal 50 to the speech recognition board 25 of the personal computer 2 via the time switch 15, media I/F 19, and the down channel “010” of the media information communication path 4. The speech recognition board 25 generates a character string corresponding to the input voice signal VD using a voice-character string conversion table, and sends the character string to the main controller 21. The main controller 21 reads out a corresponding telephone number “5621” from the storage device 23 on the basis of the received character string “YAMAMOTO”. The main controller 21 then sends this telephone number to the main controller 11 of the key service unit 1 together with a dialing control signal via the control information communication path 3.

Upon receiving the dialing control signal, the main controller 11 of the key service unit 1 detects the telephone number sent together with that control signal, and executes a dialing process to, e.g., a callee telephone terminal 51 on the basis of the telephone number. In this manner, voice dialing is done.

As described above, according to the second embodiment, prior to the beginning of the operation of the system, the down channels from the key service unit 1 to the personal computer 2, and the up channels from the personal computer 2 to the key service unit 1 are permanently set on the media information communication path 4 in correspondence with the telephone terminals 50 to 5n. Upon executing a voice dialing process, the personal computer 2 transfers the voice guidance VG to the caller telephone terminal 50 via the permanently set up channel, and the voice signal VD that represents the callee name input at the caller telephone terminal 50 is transferred to the personal computer 2 via the down channel. The voice signal undergoes speech recognition in the personal computer 2 to search for a callee telephone number using the recognition result.

Therefore, the key service unit 1 and personal computer 2 need not set up and down channels on the media information communication path 4 every time they execute an exchange service using media information. For this reason, the need for control required for setting channels used to transfer media information can be obviated, and the control load on the key service unit 1 or personal computer 2 is reduced accordingly, thus improving the processing efficiency of exchange services.

### Third Embodiment

The third embodiment of the present invention with the aforementioned arrangement will be described below.

In the third embodiment of the present invention, upon setting a down channel from the key service unit to the personal computer and an up channel from the personal computer to the key service unit on the media information communication path, it is monitored if up and down empty channels are available, and found empty channels are selected and assigned. In addition, the up and down channels are set only during a period that requires transfer of media information in an exchange service process.

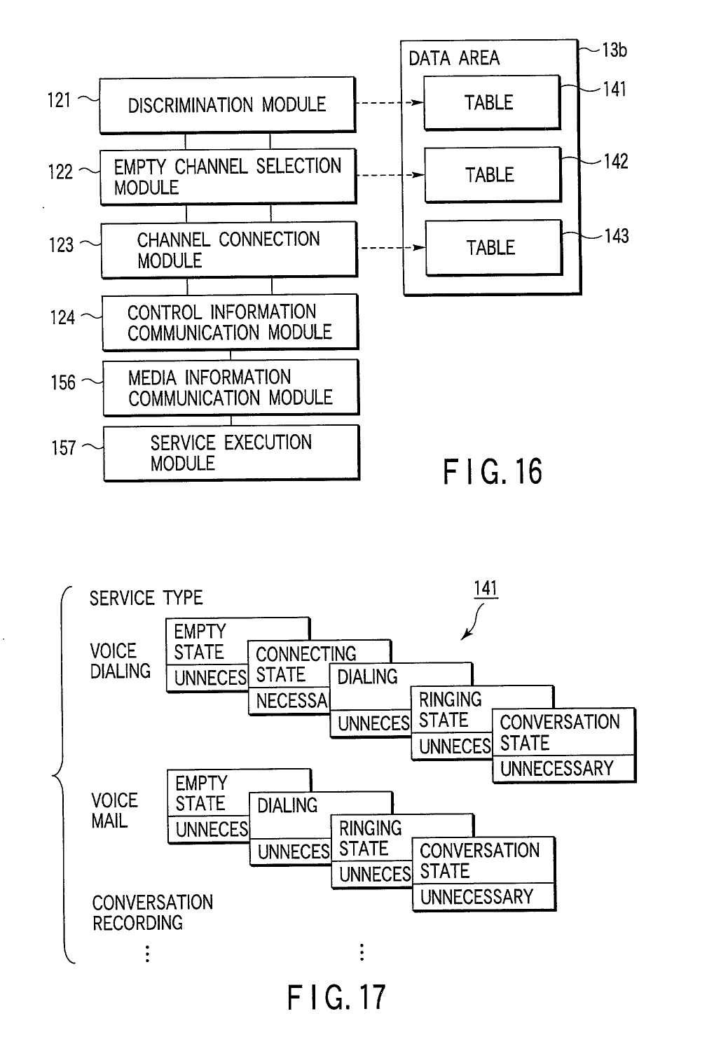

FIG. 16 is a functional block diagram showing the arrangement of principal part of a key telephone system as the third embodiment of an exchange system according to the present invention. Since the hardware arrangement of the key telephone system of this embodiment is the same as that shown in FIG. 1, a detailed description thereof will be omitted.

On the data area 13b of the storage device 13, a service dependent media information necessity/unnecessity table 141 (to be simply referred to as a table 141 hereinafter), a media information communication path bus empty/busy management table 142 (to be simply referred to as a table 142 hereinafter), and a media channel logical channel number-time switch input/output channel number correspondence table 143 (to be simply referred to as a table 143 hereinafter) are prepared.

The table 141 stores information indicating if an exchange service of interest requires transfer of media information, in units of exchange services which are expected to be provided and in correspondence with their operation states. FIG. 17 shows an example of the storage contents of the table 141.

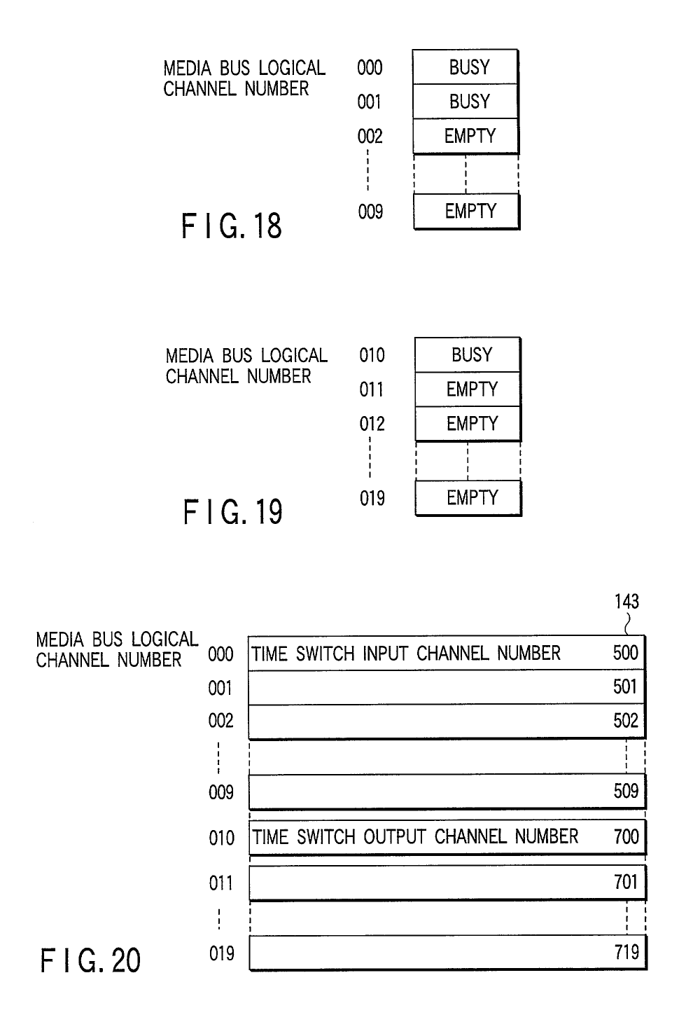

The table 142 is comprised of a media bus input-side logical channel empty/busy information table, and media bus output-side logical channel empty/busy information table. Of these tables, the media bus input-side logical channel empty/busy information table stores and manages the empty/busy states of a plurality of up channels from the personal computer 2 to the key service unit 1. FIG. 18 shows an example of the storage content of this table. On the other hand, the media bus output-side logical channel empty/busy information table stores and manages the empty/busy states of a plurality of down channels from the key service unit 1 to the personal computer 2. FIG. 19 shows an example of the storage contents of this table.

The table 143 stores the time switch input-side channel numbers of the key service unit 1 in correspondence with the numbers (media bus input-side logical channel numbers) of a plurality of up channels of the media information communication path 4, which go from the personal computer 2 to the key service unit 1. Also, the table 143 stores the time switch output-side channel numbers of the key service unit 1 in correspondence with the numbers (media bus output-side logical channel numbers) of a plurality of down channels of the media information communication path 4, which go from the key service unit 1 to the personal computer 2. FIG. 20 shows an example of the storage contents of the table 143.

On the other hand, the main controller 11 of the key service unit 1 comprises a discrimination module 121, empty channel selection module 122, channel connection module 123, control information communication module 124, media information communication module 125, and service execution module 126 as new programs for implementing exchange services using media information.

The discrimination module 121 discriminates based on the contents of the table 141 if each operation state of an exchange service of interest requires transfer of media information during execution of the exchange service process.

The empty channel selection module 122 selects empty up and down channels on the basis of the contents of the table 142 before the beginning of a given operation state that requires transfer of media information when the discrimination module 121 detects that operation state.

The channel connection module 123 connects the up channel selected by the empty channel selection module 122 to the corresponding time switch input-side channel during the execution period of the operation state that requires transfer of media information in the exchange service process. This connection is achieved by looking up the table 143.

Also, the channel connection module 123 connects the down channel selected by the empty channel selection module 122 to the corresponding time switch output-side channel. This connection is achieved by looking up the table 143.

The control information communication module 124 sends control information that designates the up and down channel numbers of the media information communication path 4, which are selected by the empty channel selection module 122, and their transmission directions, to the personal computer 2 via the control information communication path 3 when the operation state that requires transfer of media information is reached during execution of the exchange service process.

The media information communication module 125 exchanges media information with the personal computer 2 via the channels set on the media information communication path 4 after the control information communication module 124 sends the control information.

The service execution module 126 executes an exchange service such as voice dialing or the like using the media information communication path 4 on the basis of the media information exchanged by the media information communication module 125.

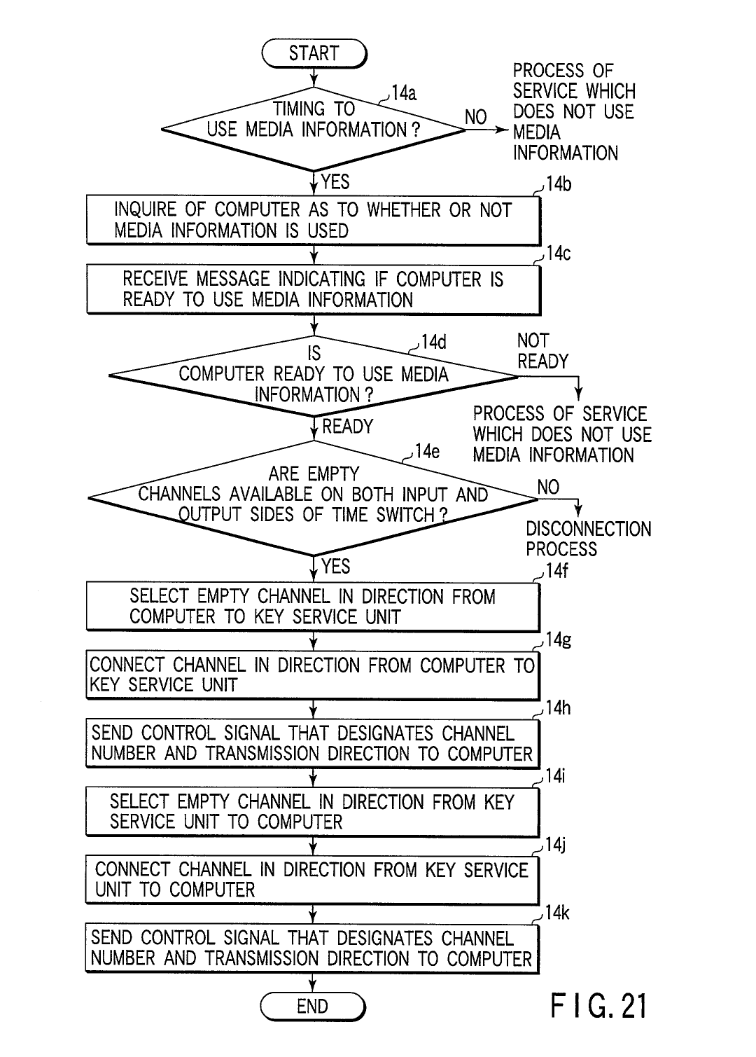

The operation of the system with the above arrangement will be explained below taking a voice dialing service as an example. FIG. 21 is a flow chart showing the control sequence and control contents by the main controller 11 of the key service unit 1.

Assume that the user of the telephone terminal 50 inputs a function number for executing a voice dialing function using a key-pad or function key (not shown) of the telephone terminal 50 after he or she picks up a handset in this state. A function number signal generated as a result of user's operation is detected by the extension interface circuit 17, and is sent to the main controller 11 via the data highway 12.

The main controller 11 starts a process for the voice dialing service, and looks up the table 141 in step 14a to check in each operation state of that service if the timing to use media information is reached. In case of the voice dialing service, it is determined that media information is required when the connection state is reached, as can be seen from the contents of the service dependent media information necessity/unnecessity table 141 shown in FIG. 17.

When the operation state that requires media information has been reached, the main controller 11 inquires in step 14b of the personal computer 2 via the control information communication path 3 as to whether or not the personal computer 2 is ready to use media information. The main controller 11 receives a reply to that inquiry from the personal computer 2 in step 14c, and checks the contents of the reply in step 14d. As a result of checking, if the personal computer 2 is ready to use media information, the flow advances to step 14e. On the other hand, if the personal computer 2 is not ready to use media information, a process of a service that does not use media information is executed.

The main controller 11 checks in step 14e by looking up the table 143 if empty channels are available from both up and down channels. If an empty channel is not available from either an up or down channel, the main controller 11 denies the voice dialing service and outputs a busy tone signal to the caller telephone terminal 50.

If empty channels are available from both the up and down channels, the main controller 11 selects an up empty channel in step 14f, and connects the selected up empty channel and the caller telephone terminal 50 via the time switch 15 and media I/F 19 in step 14g. This connection is attained by looking up the table 143.

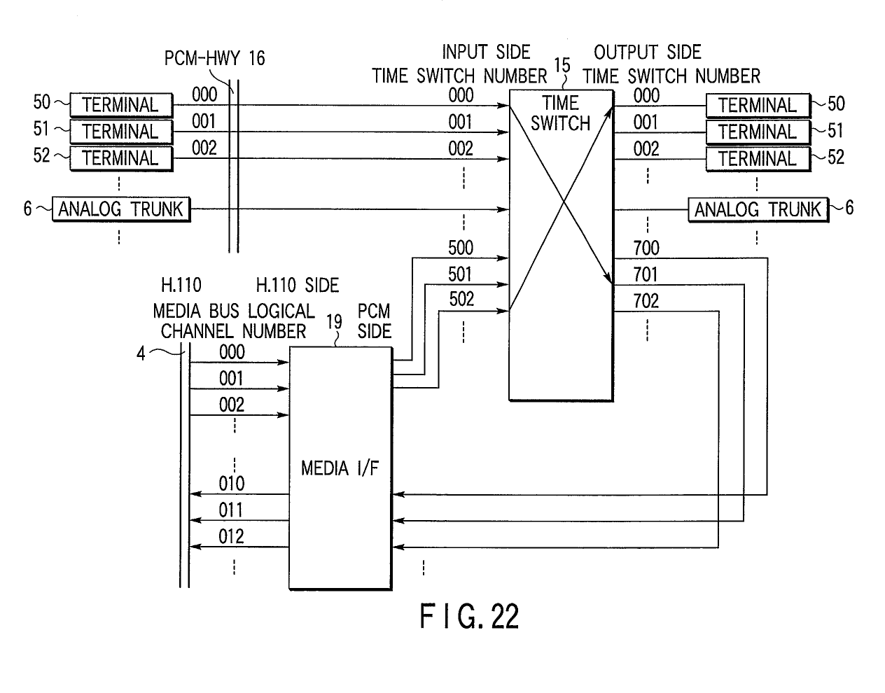

For example, assume that media bus logical channel number “002”, is selected as an up empty channel. In this case, the time switch input-side channel number corresponding to this media bus logical channel number “002”, is “502”, as shown in the table 143 in FIG. 20. For this reason, the time switch 15 connects the time switch input-side channel number “502” and the time switch output-side channel number “000” corresponding to the caller telephone terminal 50, as shown in FIG. 22.

After the communication path extending from the media bus logical channel number “002” to the caller telephone terminal 50 is assured, the main controller 11 sends control information that designates the media bus logical channel number “002” and its transmission direction to the personal computer 2 via the control information communication path 3 in step 14h.

Upon receiving this information, the personal computer 2 controls the speech synthesis board 26 to generate voice guidance VG “State callee name aloud.”, and outputs this voice guidance VG onto the up channel of the designated media bus logical channel number “002”. This voice guidance VG is transferred to the media I/F 19 of the key service unit 1 via the designated up channel “002” of the media information communication path 4, and is then transferred from the media I/F 19 to the caller telephone terminal 50 via the time switch 15. Hence, the user of the telephone terminal 50 can know the next operation contents by this voice guidance VG.

The main controller 11 of the key service unit 1 selects a down empty channel in step 14i, and connects the selected down empty channel and the caller telephone terminal via the time switch 15 and media I/F 19 in step 14j. This connection is done by looking up the table 143 as in the up transmission path mentioned above.

For example, assume that media bus logical channel number “011” is selected as a down empty channel. In this case, the time switch output-side channel number corresponding to this media bus logical channel number “011” is “701”, as shown in the table 143 in FIG. 20. For this reason, the time switch 15 connects this time switch output-side channel number “701” and the time switch input-side channel number “000” corresponding to the caller telephone terminal 50.

After the communication path extending from the caller telephone terminal 50 to the media bus logical channel number “011” is assured, the flow advances to step 14k, and the main controller 11 sends control information that designates the media bus logical channel number “011” and its transmission direction to the personal computer 2 via the control information communication path 3. Upon receiving this information, the personal computer 2 connects the down channel of the media bus logical channel number “011” to the speech recognition board 25.

Assume that the user of the telephone terminal 50 inputs the callee name “YAMAMOTO” by voice in accordance with the voice guidance VG in this state. A voice signal VD which represents the callee name “YAMAMOTO” is transferred from the telephone terminal 50 to the speech recognition board 25 of the personal computer 2 via the time switch 15, media I/F 19, and the down channel “011” of the media information communication path 4. The speech recognition board 25 generates a character string corresponding to the input voice signal VD using a voice-character string conversion table, and sends the character string to the main controller 21. The main controller 21 reads out a corresponding telephone number “5621” from the storage device 23 on the basis of the received character string “YAMAMOTO”. The main controller 21 then sends this telephone number to the main controller 11 of the key service unit 1 together with a dialing control signal via the control information communication path 3.

Upon receiving the dialing control signal, the main controller 11 of the key service unit 1 detects the telephone number sent together with that control signal, and executes a dialing process to, e.g., a callee telephone terminal 51 on the basis of the telephone number. In this manner, voice dialing is done.

As described above, according to the third embodiment, it is checked during execution of a voice dialing service if each operation state of that service requires transfer of media information, and when the operation state that requires transfer of media information has been reached, up and down channels are set on the media information communication path 4.

Therefore, the transmission channels are set on the media information communication path 4 during only the period of the operation state that requires transfer of media information in the execution period of the voice dialing service. For this reason, the transmission channels on the media information communication path 4 can be used more effectively, thus improving the use efficiency of channels.

In addition, upon setting transmission channels on the media information communication path 4, up and down channels are monitored to select empty channels. For this reason, both the up and down channels on the media information communication path 4 can be dynamically set, and the number of channels to be prepared on the media information communication path 4 can be smaller than the number of telephone terminals 50 to 5n. As a result, the transmission capacity of the media information communication path 4 can be reduced. In addition, since the number of channels on the media information communication path 4 need not be increased/decreased in correspondence with the number of telephone terminals 50 to 5n, new telephone terminals can be very easily added to the telephone terminals 50 to 5n.

Furthermore, when the operation state that requires transfer of media information has been reached, the key service unit 1 inquires of the personal computer 2 as to whether or not it is ready to use media information, and only when the personal computer 2 sends back a reply indicating that it is ready to use media information, channels for transferring media information are set. With this control, since the channels for transferring media information are set after the state of the personal computer 2 is confirmed, the processing efficiency of the key service unit 1 can be improved by omitting an inefficient processing sequence.

### Fourth Embodiment

The fourth embodiment of the present invention with the aforementioned arrangement will be explained below.

In the fourth embodiment of the present invention, up channels going from the personal computer to the key service unit are permanently set in advance in correspondence with the telephone terminals, and as for a down channel going from the key service unit to the personal computer, the personal computer selects an empty channel and informs the key telephone key service unit of that channel, and the key service unit sets the channel.

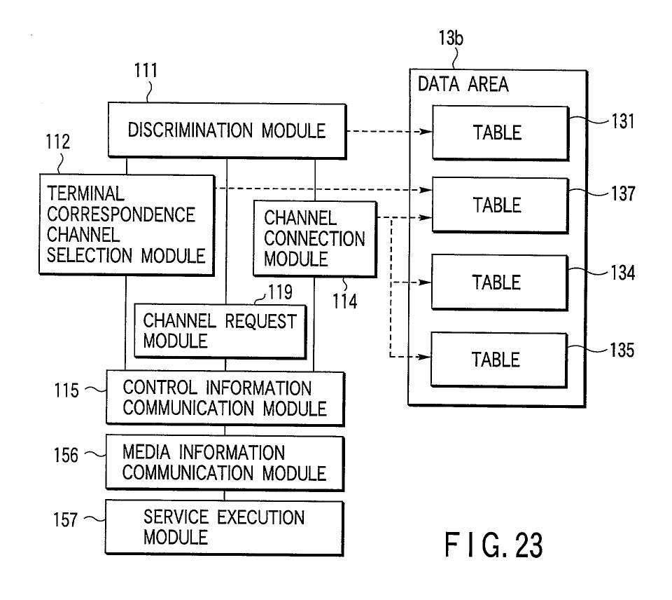

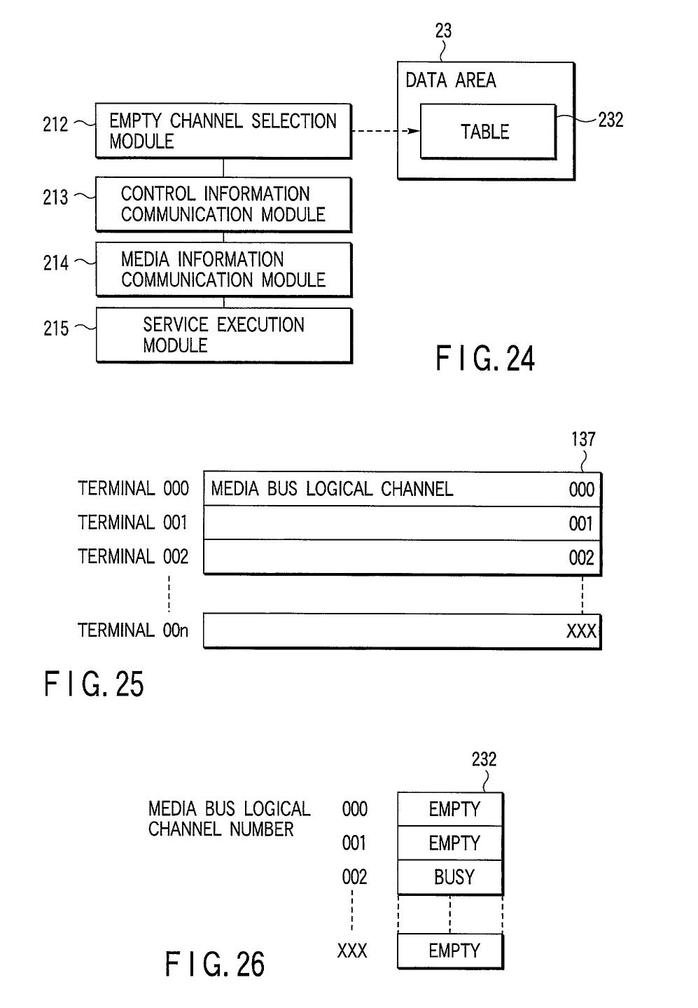

FIG. 23 shows the arrangement of principal part of the key service unit 1, and FIG. 24 shows the arrangement of principal part of the personal computer 2. Since the hardware arrangement of the key telephone system of this embodiment is the same as that in FIG. 1, a description thereof will be omitted. Also, the same reference numerals in FIG. 23 denote the same functional blocks as in FIG. 3, and a detailed description thereof will be omitted.

On the data area 13b of the storage device 13, a terminal correspondence media bus logical channel number table 137 (to be simply referred to as a table 137 hereinafter) is prepared in addition to the tables 131, 134, and 135.

Of these tables, the table 137 stores the numbers (media bus input logical channel numbers) of up channels of the media information communication path 4, which go from the personal computer 2 toward the key service unit 1 in correspondence with the telephone terminals 50 to 5n. FIG. 25 shows an example of the storage contents of the table 137.

On the other hand, the main controller 11 comprises a discrimination module 111, terminal correspondence channel selection module 112, channel connection module 114, control information communication module 115, channel request module 119, media information communication module 156, and service execution module 157 as new functional programs that implement exchange services using media information.

Of these modules, the terminal correspondence channel selection module 112 reads out from the table 137 the number of an up channel corresponding to the telephone terminal which is to receive an exchange service, upon activating the exchange service using the up channel of the media information communication path 4.

The channel request module 119 sends an empty down channel seize request to the personal computer 2 via the control information communication path 3, and receives a reply from the personal computer 2 upon activating an exchange service using the down channel of the media information communication path 4.

The channel connection module 114 looks up the tables 137 and 135 before the beginning of the operation of the key service unit 1 to permanently connect time switch output-side channels corresponding to the telephone terminals 50 to 5n and time switch input-side channels connected to the up channels of the media information communication path 4.

Also, the channel connection module 114 connects an empty down channel indicated by the reply from the personal computer 2 to a corresponding time switch input-side channel by looking up the table 134 upon executing an exchange service using media information.

The control information communication module 115 sends control information that designates a down channel set in accordance with the empty down channel indicated by the reply from the personal computer 2, and its transmission direction to the personal computer 2 via the control information communication path 3 prior to transfer of media information, when an exchange service using the media information communication path 4 is activated. Also, the module 115 sends control information that designates an up channel set in correspondence with the telephone terminal which is to receive an exchange service, and its transmission direction to the personal computer 2 via the control information communication path 3.

The media information communication module 156 exchanges media information with the personal computer 2 via the channels set on the media information communication path 4 after the control information is exchanged by the control information communication module 115.

The service execution module 157 executes an exchange service such as voice dialing or the like using the media information communication path 4 on the basis of the media information exchanged by the media information communication module 156.

A data area assured on the storage device 23 of the personal computer 2 comprises a media information communication path empty/busy management table 232 (to be simply referred to as a table 232 hereinafter) in addition to a table for storing a telephone book and the like.

The table 232 stores the empty/busy states of a plurality of up channels of the media information communication path 4, which go from the personal computer 2 to the key service unit 1. FIG. 26 shows an example of the storage contents of the table 232.

The main controller 21 of the personal computer 2 has an empty channel selection module 212, control information communication module 213, media information communication module 214, and service execution module 215 as new functional programs that implement exchange services using media information.

The empty channel selection module 212 selects an empty down channel on the basis of the table 232 upon receiving an empty down channel seize request from the key service unit 1 via the control information communication path 3.

The control information communication module 213 exchanges control information with the key service unit 1 via the control information communication path 3, and sends control information that designates the down channel number of the media information communication path 4, which is selected by the empty channel selection module 212, and its transmission direction, to the key service unit 1 via the control information communication path 3.

The media information communication module 214 exchanges media information with the key service unit 1 via the channels set on the media information communication path 4, after the control information communication module 213 sends the control information.

The service execution module 215 executes an exchange service such as voice dialing or the like using the media information communication path 4 on the basis of the media information exchanged by the media information communication module 214.

The operation of the system with the above arrangement will be explained below taking a voice dialing service as an example.

Prior to the beginning of the operation of the system, the key service unit 1 executes a process for permanently assigning, to the telephone terminals 50 to 5n, up channels of the media information communication path 4, which go from the personal computer 2 to the key service unit 1.

More specifically, the main controller 11 acquires up channel numbers (media bus input logical channel numbers) of the media information communication path 4 corresponding to the telephone terminals 50 to 5n from the table 137, and obtains time switch input-side channel numbers corresponding to those logical channel numbers from the storage contents of the table 135. The main controller 11 then permanently connects the obtained time switch input-side channels and time switch output-side channels corresponding to the telephone terminals 50 to 5n via the time switch 15.

For example, assume that media bus logical channel numbers “000”, “001”, “002”, . . . , are assigned to the telephone terminals 50 to 5n “000”, “001”, “002”, . . . , as shown in FIG. 25, and time switch input-side channel numbers “500”, “501”, “502”, . . . , are assigned to those media bus input logical channel numbers “000”, “001”, “002”, . . . , as shown in FIG. 9.

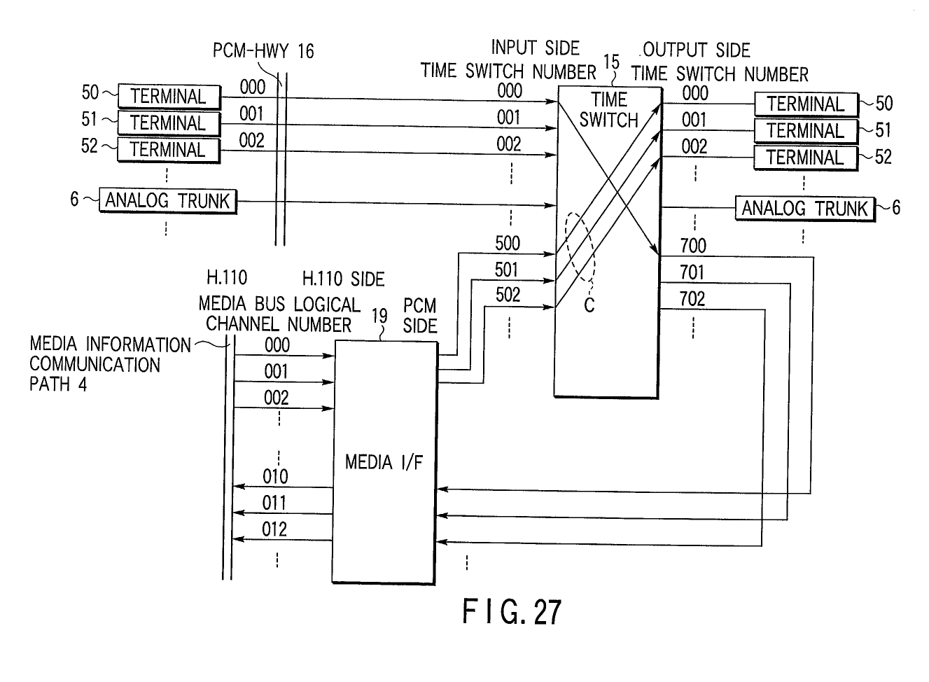

In this case, taking the telephone terminal 50 as an example, the media bus logical channel number “000” is obtained from the table 137, and the time switch output-side channel number “500” is obtained from the table 135 in correspondence with this media bus logical channel number “000”. Then, the time switch 5 permanently connects a time switch output-side channel with this number “500”, and a time switch output-side channel with number “000” to which the telephone terminal 50 is connected. Likewise, the remaining telephone terminals 51 to 5n are connected to the media bus input logical channels via the time switch 15. C in FIG. 27 indicates that connection state.

As a result of permanent connection, the telephone terminals 50 to 5n are always connected to the up channels of the media information communication path 4, and media information output from the personal computer 2 can be transferred to the telephone terminals 50 to 5n via the up channels of the media information communication path 4, and the media I/F 19 and time switch 15 in the key service unit 1.

Assume that the user of the telephone terminal 50 inputs a function number for executing a voice dialing function using a key-pad or function key (not shown) of the telephone terminal 50 after he or she picks up a handset in this state. A function number signal generated as a result of user's operation is detected by the extension interface circuit 17, and is sent to the main controller 11 via the data highway 12.

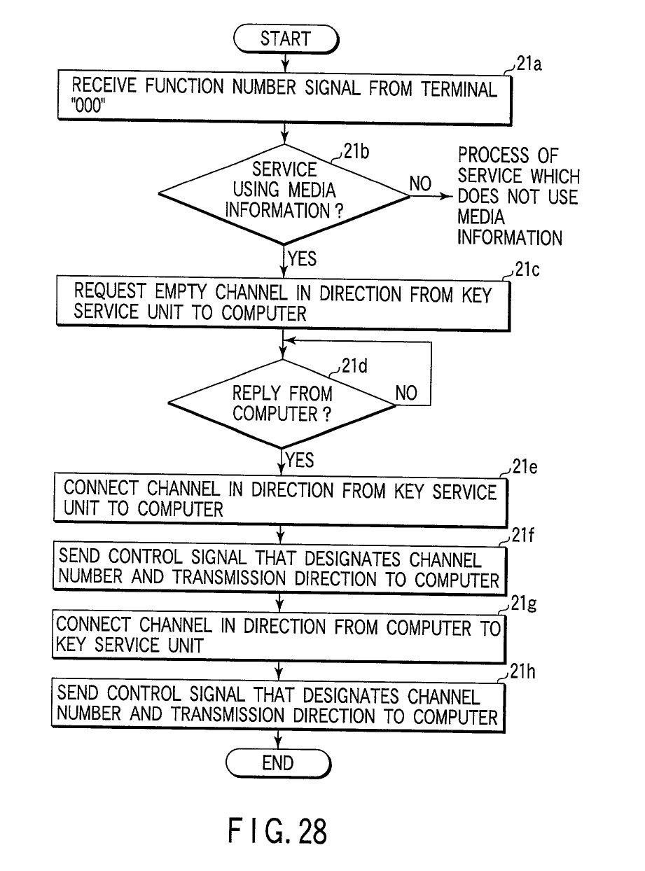

Upon detecting the function number signal in step 21a in FIG. 28, the flow advances to step 21b, and the main controller 11 checks based on the contents of the table 131 if the caller telephone terminal 50 requests an exchange service using media information. If the requested exchange service uses media information, the flow advances to step 21c. If it is determined that the requested exchange service is a normal service that does not use media information, a normal dialing process is executed.

The main controller 11 sends a down channel seize request of the media information communication path 4 to the personal computer 2 via the control information communication path 3 in step 21c. Upon receiving this request, the main controller 21 of the personal computer 2 selects an empty down channel on the basis of the contents of the media information communication path empty/busy management table assured on the storage device 23, and sends a reply indicating the selected channel to the main controller 11 of the key service unit 1.

The main controller 11 of the key service unit 1 monitors a reply from the personal computer 2 in step 21d after it sends the seize request. Upon receiving the reply, the main controller 11 looks up the table 134 in step 21e to connect a time switch output-side channel corresponding to the down channel indicated by the reply, and a time switch input-side channel corresponding to the caller telephone terminal 50 via the time switch 15.

For example, assume that the personal computer 2 informs media bus output logical channel number “010” as an empty channel. At this time, since time switch output-side channel number “700” is registered in the table 134, as shown in FIG. 7, the time switch 15 connects the time switch output-side channel number “700” and the time switch input-side channel with number “000” corresponding to the caller telephone terminal 50, as shown in FIG. 24.

In this manner, a path extending from the caller telephone terminal 50 to the down channel of the media information communication path 4 via the time switch 15 and media I/F 19 is assured.

The main controller 11 generates control information that designates the media bus output logical channel number “010” and the transmission direction of media information (key service unit 1→personal computer 2), and sends that control information to the personal computer 2 via the control communication path 3 in step 21f. Upon receiving this information, the personal computer 2 connects the down channel with the media bus channel number “010” to the speech recognition board 25.

The main controller 11 then selects an up channel of the media information communication path 4, which goes from the personal computer 2 toward the key service unit 1. That is, the main controller 11 looks up the table 137 to select media bus input logical channel number “000” corresponding to “number 000” of the telephone terminal 50 in step 21g. At this time, an up channel from the personal computer 2 to the key service unit 1 has already been permanently assigned, as described above. For this reason, a media information up transfer path extending from the personal computer 2 to the caller telephone terminal 50 via the up channel of the media information communication path 4, media I/F 19, and time switch 15 is assured by selecting media bus logical channel number “000”.

The main controller 11 generates control information which designates media bus input logical channel number “000” and the transmission direction of media information (personal computer 2→key service unit 1), and sends this control information to the personal computer 2 via the control information communication path 3 in step 21h.

Upon receiving this information, the personal computer 2 controls the speech synthesis board 26 to generate voice guidance VG “State callee name aloud.”, and outputs this voice guidance VG onto the up channel of the designated media bus logical channel number “000”. This voice guidance VG is transferred to the media I/F 19 of the key service unit 1 via the designated up channel “000” of the media information communication path 4, and is then transferred from the media I/F 19 to the caller telephone terminal 50 via the time switch 15. Hence, the user of the telephone terminal 50 can know the next operation contents by this voice guidance VG.

The user of the telephone terminal 50 inputs the callee name “YAMAMOTO” by voice in accordance with the voice guidance VG. A voice signal VD which represents the callee name “YAMAMOTO” is transferred from the telephone terminal 50 to the speech recognition board 25 of the personal computer 2 via the time switch 15, media I/F 19, and the down channel “010” of the media information communication path 4. The speech recognition board 25 generates a character string corresponding to the input voice signal VD using a voice-character string conversion table, and sends the character string to the main controller 21. The main controller 21 reads out a corresponding telephone number “5621” from the storage device 23 on the basis of the received character string “YAMAMOTO”. The main controller 21 then sends this telephone number to the main controller 11 of the key service unit 1 together with a dialing control signal via the control information communication path 3.

Upon receiving the dialing control signal, the main controller 11 of the key service unit 1 detects the telephone number sent together with that control signal, and executes a dialing process to, e.g., a telephone terminal 51 on the basis of the telephone number. In this manner, voice dialing is executed.

As described above, according to the fourth embodiment, a down channel of the media information communication path 4, which goes from the key service unit 1 to the personal computer 2 can be dynamically set.

Upon setting the down channel, the key service unit 1 sends an empty channel seize request to the personal computer 2, which selects an empty channel and sends a reply to the key service unit 1. The key service unit 1 sets a down channel based on the reply. For this reason, the personal computer 2 can share the empty channel management/selection function, and the control load on the key service unit 1 can be reduced accordingly.

### Fifth Embodiment

The fifth embodiment of the present invention with the aforementioned arrangement will be described below.

In the fifth embodiment of the present invention, upon executing an exchange service, the personal computer checks if that exchange service uses media information, monitors an empty up channel to be set on the media information communication path 4, and selects and sets an empty channel.

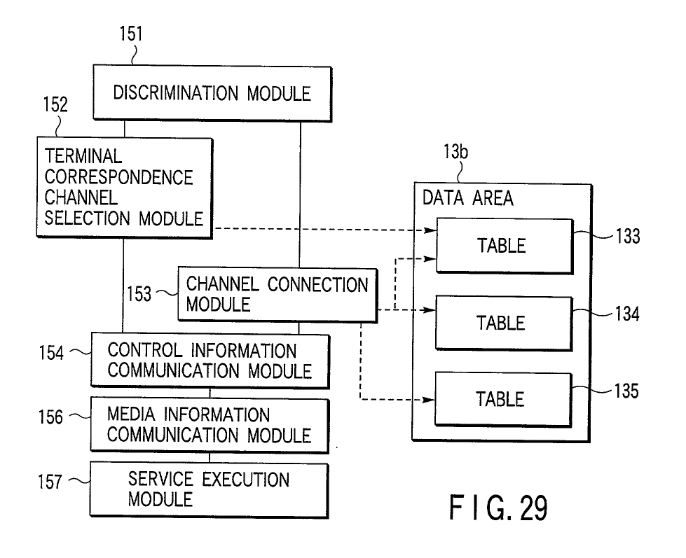

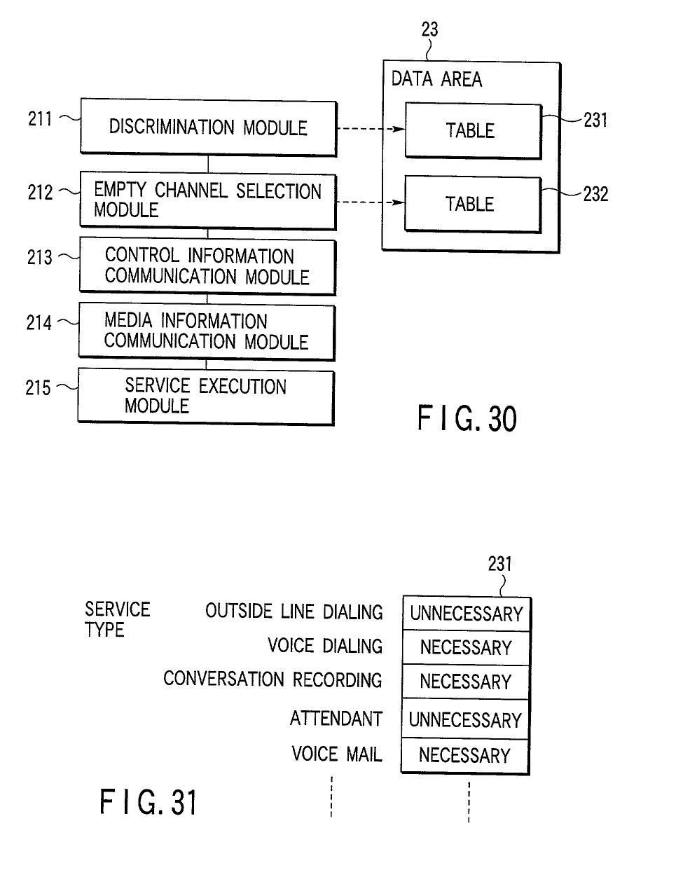

FIG. 29 shows the arrangement of principal part of the key service unit 1, and FIG. 30 shows the arrangement of principal part of the personal computer 2.

Since the hardware arrangement of the key telephone system of this embodiment is the same as that shown in FIG. 1, a detailed description thereof will be omitted. The same reference numerals in FIG. 29 denote the same functional blocks as in FIG. 3, and a detailed description thereof will be omitted. Furthermore, the same reference numerals in FIG. 30 denote the same functional blocks as in FIG. 24, and a detailed description thereof will be omitted.

The data area assured on the storage device 23 of the personal computer stores a service dependent media information necessity/unnecessity table 231 (to be simply referred to as a table 231 hereinafter) and the table 232 in addition to a table for storing a telephone book and the like.

The table 231 stores information indicating if an exchange service of interest uses media information, in correspondence with the types of exchange services which are expected to be executed. FIG. 31 shows an example of the storage contents of the table 231.

The table 232 stores the empty/busy states of a plurality of up channels of the media information communication path 4, which go from the personal computer 2 toward the key service unit 1.

The main controller 21 of the personal computer 2 has a discrimination module 211, empty channel selection module 212, control information communication module 213, media information communication module 214, and service execution module 215 as new functional programs for implementing exchange services using media information.

The discrimination module 211 looks up the table 231 upon receiving an exchange service activation message from the key service unit 1 to check if that exchange service uses media information. The module 211 informs the key service unit 1 of that discrimination result via the control information communication path 3.

The empty channel selection module 212 selects an empty up channel based on the table 232 when the activated service uses an up channel of the media information communication path 4, which goes from the personal computer 2 to the key service unit 1.

The control information communication module 213 sends control information that designates the up channel number of the media information communication path 4, which is selected by the empty channel selection module 212, and its transmission direction, to the key service unit 1 via the control information communication path 3, when an exchange service using the media information communication path 4 is activated.

The media information communication module 214 exchanges media information with the key service unit 1 via the channels set on the media information communication path 4, after the control information communication module 213 sends the control information.

The service execution module 215 executes an exchange service such as voice dialing or the like using the media information communication path 4 on the basis of the media information exchanged by the media information communication module 214.

On the other hand, on the data area 13b of the storage device 13 of the key service unit 1, the tables 133, 134, and 135 are prepared.

The main controller 11 of the key service unit 1 comprises a discrimination module 151, terminal correspondence channel selection module 152, channel connection module 153, and control information communication module 154 as new functional programs for implementing exchange services using media information.

The discrimination module 151 executes an exchange service using media information when the discrimination result of the discrimination module 211 sent from the personal computer 2 indicates an exchange service using media information, and executes an exchange service process by the key service unit 1 alone when that result indicates an exchange service which does not use media information.

The terminal correspondence channel selection module 152 reads out from the table 133 the number of a down communication channel corresponding to the telephone terminal for which an exchange service is executed, when the exchange service using a down communication channel of the media information communication path 4 is activated.

The channel connection module 154 permanently connects time switch input-side channels to which the telephone terminals 50 to 5n are connected, and time-switch output-side channels connected to down channels of the media information communication path 4 by looking up the tables 133 and 134 before the beginning of the operation of the key service unit 1.

Also, the channel connection module 154 connects the up channel of the media information communication channel 4, which is selected by the empty channel selection module 212 of the personal computer 2, to a time switch output-side channel by looking up the table 135, upon executing an exchange service using media information.

The control information communication module 154 sends control information that designates the down channel number of the media information communication path 4 selected by the terminal correspondence channel selection module 152 and its transmission direction, to the personal computer 2 via the control information communication path 3, when an exchange service using the media information communication path 4 is activated.

The media information communication module 155 exchanges media information with the personal computer 2 via the channels set on the media information communication path 4 after the control information communication module 154 sends the control information.

The service execution module 156 executes an exchange service such as voice dialing or the like using the media information communication path 4 on the basis of the media information exchanged by the media information communication module 155.

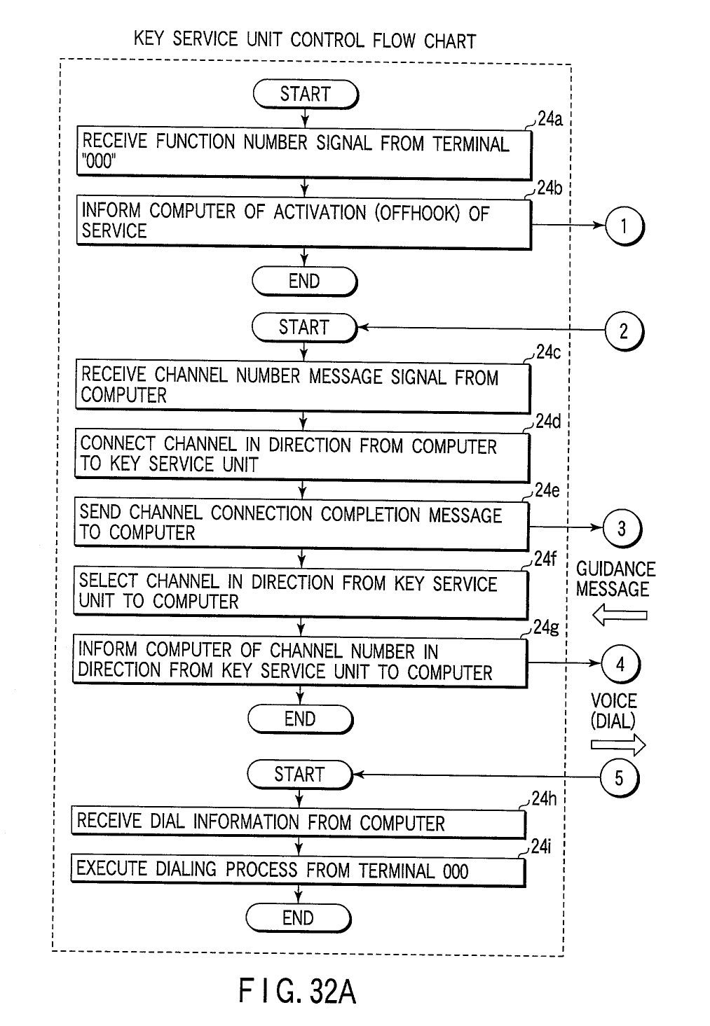

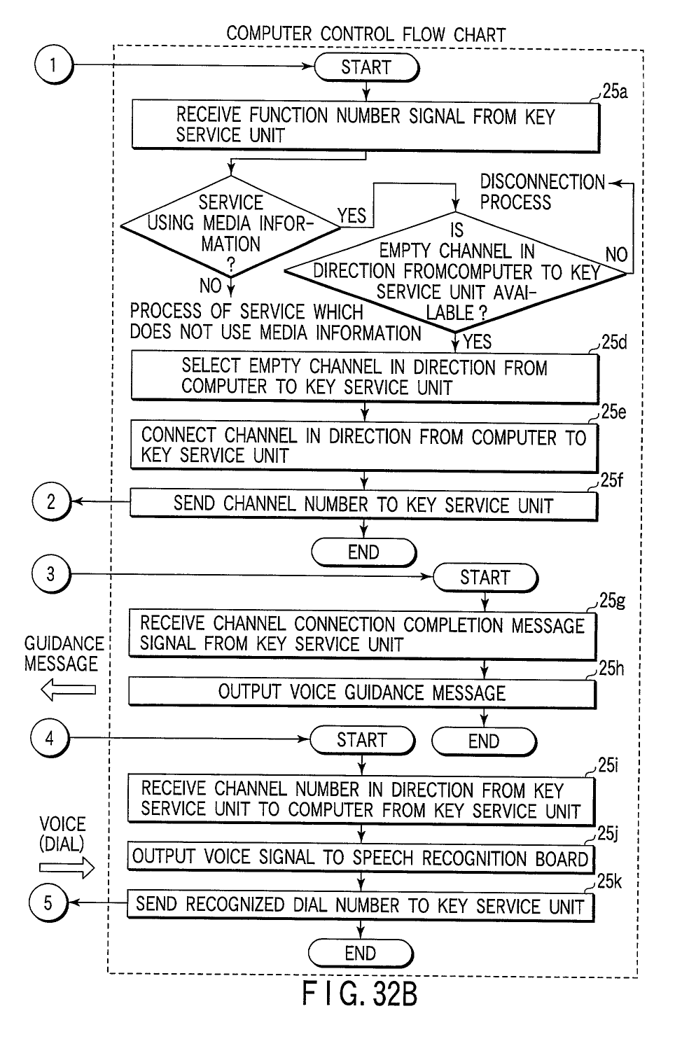

The operation of the system with the above arrangement will be explained below taking a voice dialing service as an example. FIG. 32 is a flow chart showing the control sequence and control contents by the main controller 11 of the key service unit 1 and the main controller 21 of the personal computer 2.

Prior to the beginning of the operation of the system, the key service unit 1 executes a process for permanently assigning, to the telephone terminals 50 to 5n, down channels of the media information communication path 4, which go from the key service unit 1 to the personal computer 2.

More specifically, the main controller 11 acquires down channel numbers (media bus output logical channel numbers) of the media information communication path 4 corresponding to the telephone terminals 50 to 5n from the table 133, and obtains time switch output-side channel numbers corresponding to those logical channel numbers from the storage contents of the table 134. The main controller 11 then permanently connects the obtained time switch output-side channels and time switch input-side channels corresponding to the telephone terminals 50 to 5n via the time switch 15.

With this connection control, the telephone terminals 50 to 5n “000”, “001”, “002”, . . . are permanently connected to time switch output-side channel numbers “700”, “701”, “702”, . . . corresponding to the media bus logical channel numbers “010”, “011”, “012”, . . . . This connection state is the same as that shown in A of FIG. 10.

As a result of permanent connection, the telephone terminals 50 to 5n are always connected to the down channels of the media information communication path 4, and media information output from the personal computer 2 can be transferred onto the down channels of the media information communication path 4.

Assume that the user of the telephone terminal 50 inputs a function number for executing a voice dialing function using a key-pad or function key (not shown) of the telephone terminal 50 after he or she picks up a handset in this state. A function number signal generated as a result of user's operation is detected by the extension interface circuit 17, and is sent to the main controller 11 via the data highway 12.

Upon detecting the function number signal in step 24a in FIG. 32, the flow advances to step 24b, and the main controller 11 informs the personal computer 2 of that offhook, i.e., the activation message of the exchange service via the control information communication path 3.

Upon receiving the function number signal from the key service unit 1 in step 25a, the main controller 21 of the personal computer 2 checks in step 25b based on the contents of the table 231 if the caller telephone terminal 50 requests an exchange service that uses media information. If the requested services uses media information, the flow advances to step 25c.

As a result of checking, if the request exchange service is a normal service that does not use media information, the main controller 21 informs the key service unit 1 of a message indicating this via the control information communication path 3. Upon receiving this message, the key service unit 1 executes a normal dialing process.

The main controller 21 checks in step 25c based on the contents of the table 232 if an empty channel is available in the up channels of the media information communication path 4. If an empty channel is found, the flow advances to step 25d to select that empty channel, and the speech synthesis board 26 is connected to the selected empty channel in step 25e. Assuming that media bus logical channel number “000” is empty, as shown in FIG. 26, the speech synthesis board 26 is connected to this channel. The main controller 21 then sends control information which indicates the selected up channel number (media bus logical channel number “000”) and its transmission direction (personal computer 2→key service unit 1) to the key service unit 1 via the control information communication path 3.

Upon receiving the control information that indicates an up channel and its transmission direction from the personal computer 2 in step 24c, the main controller 11 of the key service unit 1 connects that up channel and the caller telephone terminal 50 in step 24d. That is, the main controller 11 looks up the table 135 to connect a time switch input-side channel corresponding to the up channel, and a time switch output-side channel corresponding to the caller telephone 50 via the time switch 15.

For example, in the table 135, time switch input-side channel number “500” is registered in correspondence with the media bus logical channel number “000” sent from the personal computer 2, as shown in FIG. 9. Hence, the time switch 15 connects this time switch input-side channel number “500” and the time switch output-side channel with number “000” corresponding to the caller telephone terminal 50, as shown in FIG. 10.

Upon completion of connection of a media information transfer path in the key service unit 1, the main controller 11 sends a connection completion message to the personal computer 2 via the control information communication path 3 in step 24e.

Upon receiving the connection completion message in step 25g, the main controller 21 of the personal computer 2 inputs a send instruction of voice guidance to the speech synthesis board 26 in step 25h. In response to this instruction, the speech synthesis board 26 generates voice guidance VG “State callee name aloud”. This voice guidance VG is transferred to the media I/F 19 of the key service unit 1 via the designated up channel “000” of the media information communication path 4, and is then transferred from the media I/F 19 to the caller telephone terminal 50 via the time switch 15. Hence, the user of the telephone terminal 50 can know the next operation contents by this voice guidance VG.

After the connection completion message is sent, the flow advances to step 24f, and the main controller 11 of the key service unit 1 looks up the terminal correspondence media bus logical channel number table 133 to select media bus logical channel number “010” corresponding to “number 000” of the telephone terminal 50. At this time, a down channel from the key service unit 1 to the personal computer 2 has already been permanently assigned, as described above. For this reason, a media information transfer path extending from the caller telephone terminal 50 to the personal computer 2 via the time switch 15, media I/F 19, and the down channel of the media information communication path 4 is assured by selecting media bus logical channel number “010”.

The main controller 11 generates control information that designates the media bus logical channel number “010” and the transmission direction (key service unit 1→personal computer 2) of media information, and sends this control information to the personal computer 2 via the control information communication path 3 in step 24g.

Upon receiving this control information from the key service unit 1 in step 25i, the main controller 21 of the personal computer 2 connects the down channel of media bus logical channel number “010” to the speech recognition board 25 (step 25j).

Therefore, if the user of the telephone terminal 50 inputs the callee name “YAMAMOTO” by voice in accordance with the voice guidance VG in that state, a voice signal VD which represents the callee name “YAMAMOTO” is transferred from the telephone terminal 50 to the personal computer 2 via the time switch 15, media I/F 19, and the down channel “010” of the media information communication path 4, and is input to the speech recognition board 25. The speech recognition board 25 generates a character string corresponding to the input voice signal VD using a voice-character string conversion table, and sends the character string to the main controller 21. The main controller 21 reads out a corresponding telephone number “5621” from the storage device 23 on the basis of the received character string “YAMAMOTO” in step 25k. The main controller 21 then sends this telephone number as dial information to the main controller 11 of the key service unit 1 together with a dialing control signal via the control information communication path 3.

The main controller 11 of the key service unit 1 detects the telephone number sent from the personal computer 2 together with the dialing control signal in step 24h, and executes a dialing process to, e.g., a callee telephone terminal 51 on the basis of the telephone number in step 24i. In this manner, voice dialing is done.

As described above, according to the fifth embodiment, upon executing an exchange service, the personal computer 2 checks if that exchange service uses media information, monitors empty ones of up channels to be set on the media information communication path 4, and selects an empty channel. Therefore, most of processes that pertain to the media information are done by the personal computer 2, and changes in hardware and software of the key service unit 1 can be minimized. In this manner, the system can be easily implemented by changing the arrangement a little.

### Sixth Embodiment

The sixth embodiment of the present invention with the aforementioned arrangement will be described below.

In the sixth embodiment of the present invention, media information and control information are transferred via a single media information communication path between the key service unit and personal computer.

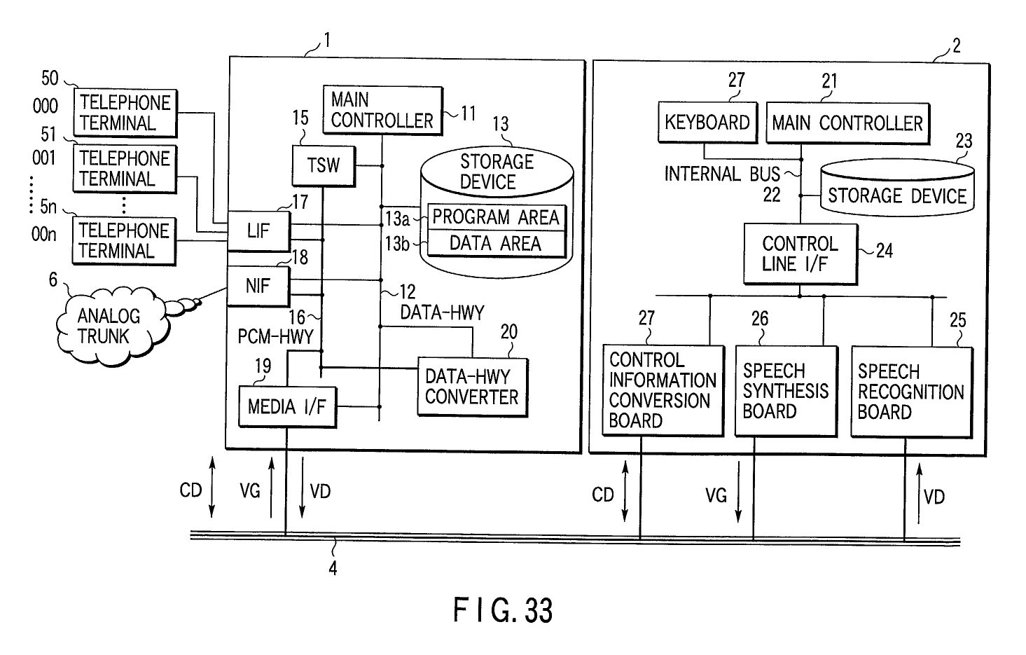

FIG. 33 is a block diagram showing the arrangement of a key telephone system as the sixth embodiment of an exchange system according to the present invention. Note that the same reference numerals in FIG. 33 denote the same parts as in FIG. 1.

The system of this embodiment comprises a key service unit 1, a plurality of telephone terminals 50 to 5n connected to the key service unit 1 via an extension, and a personal computer 2 connected to the key service unit 1 via a media information communication path 4.

A data highway converter (DATA-HWY converter) 20 is newly connected to a main controller 11 of the key service unit 1. The data highway converter 20 executes a conversion process for converting control information on a data highway 12 into a format that can be transferred on the media information communication path 4, and outputting the converted information, and a conversion process for converting control information coming from the personal computer 2 via the media information communication path 4 into a format that can be transferred on the data highway 12.

On the other hand, a control information conversion board 27 is newly added to the personal computer 2. The control information conversion board 27 performs format conversion of control information CD between the media information communication path 4 and an internal bus 22 of the personal computer 2.

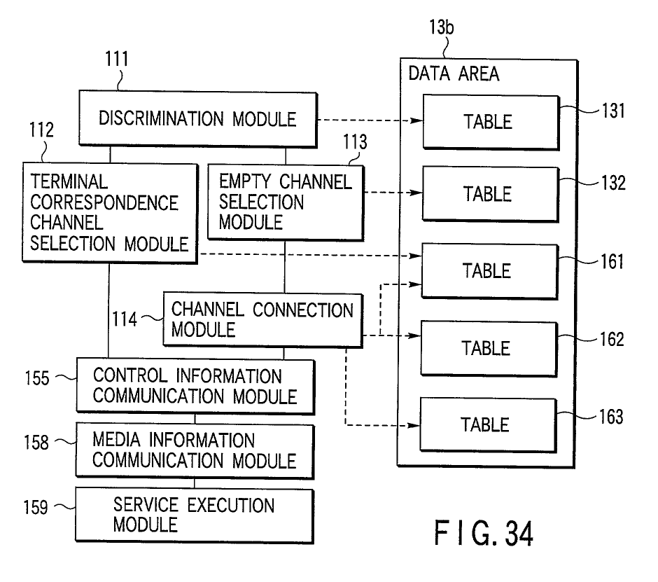

The key service unit 1 comprises the following new functions to implement an exchange service process using media information. FIG. 34 is a functional block diagram showing the arrangement of the key service unit 1.

More specifically, tables 131, 133, 161, 162, and 163 are prepared on a data area 13 of a storage device 13.

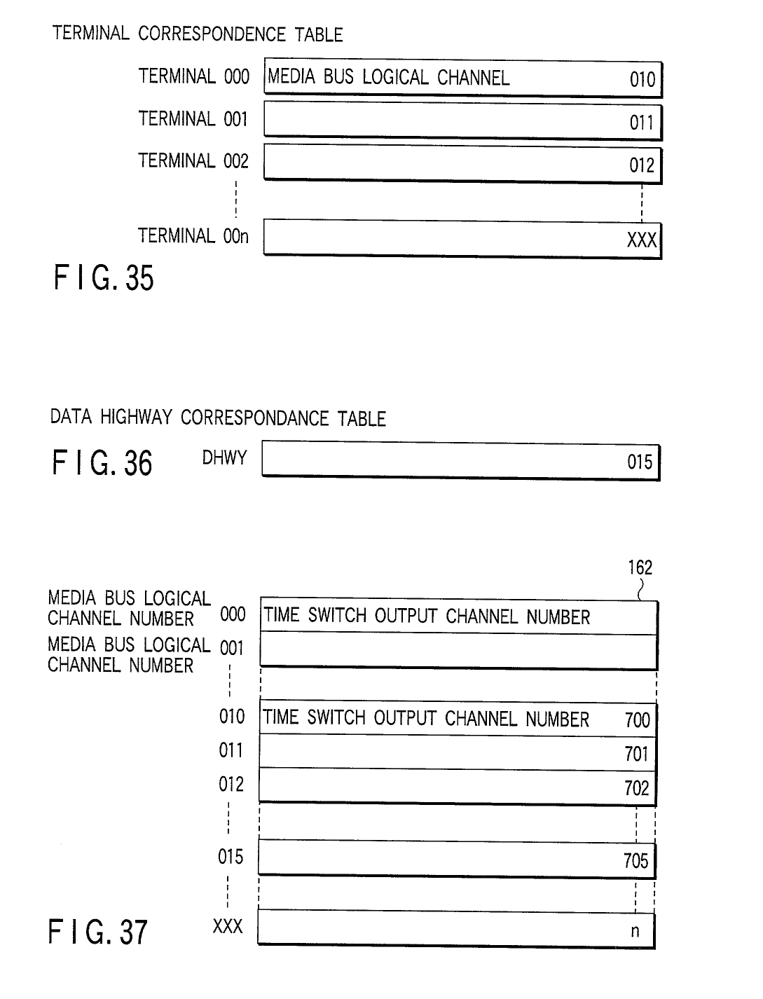

Of these tables, the table 161 is comprised of a terminal correspondence table and data highway correspondence table. The terminal correspondence table stores the numbers (media bus output logical channel numbers) of down channels of the media information communication path, which go from the key service unit 1 to the personal computer 2, in correspondence with the telephone terminals 50 to 5n. FIG. 35 shows an example of the storage contents of this table. The data highway correspondence table stores a media bus output logical channel number corresponding to the data highway 12. FIG. 36 shows an example of the storage contents of this table.

The table 162 stores the time switch output-side channel numbers of the key service unit 1 in correspondence with the numbers of a plurality of down communication channels of the media information communication path 4, which go from the key service unit 1 to the personal computer 2. FIG. 37 shows an example of the storage contents of the table 162.

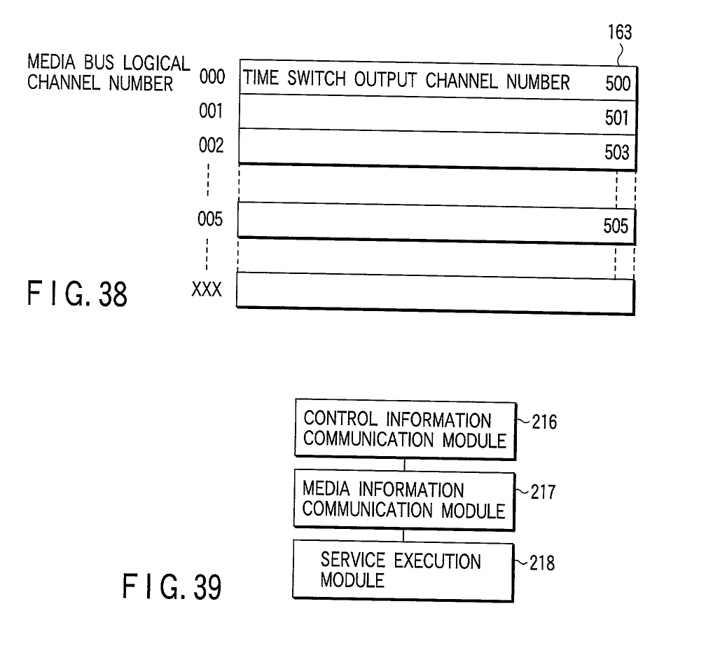

The table 163 stores the time switch input-side channel numbers of the key service unit 1 in correspondence with the numbers of a plurality of up channels of the media information communication path 4, which go from the personal computer 2 to the key service unit 1. FIG. 38 shows an example of the storage contents of the table 163.

The main controller 11 of the key service unit 1 comprises a discrimination module 111, terminal correspondence channel selection module 112, empty channel selection module 113, channel connection module 114, control information communication module 155, media information communication module 156, and service execution module 157 as new functional programs for implementing exchange services using media information.

Of these modules, the control information communication module 155 sends control information that indicates the up channel number of the media information communication path 4, which is selected by the empty channel selection module 113, and its transmission direction, and control information that designates the down channel number of the media information communication path 4, which is selected by the terminal correspondence channel selection module 112, and its transmission direction, to the personal computer 2 via a down channel, which is assured in advance on the media information communication path 4 and is exclusively used to transfer control information, when an exchange service that uses the media information communication path 4 is activated.

The media information communication module 155 exchanges media information with the personal computer 2 together with control information when an exchange service that uses the media information communication path 4 is activated.

The service execution module 156 executes an exchange service such as voice dialing or the like that uses the media information communication path 4 on the basis of the media information exchanged by the media information communication module 155.

On the other hand, a main controller 21 of the personal computer comprises a control information communication module 216, media information communication module 217, and service execution module 218, as shown in FIG. 39.

The control information communication module 216 exchanges control information with the key service unit 1 via the down channel, which is assured in advance on the media information communication path 4 and is exclusively used to transfer control information.

The media information communication module 217 exchanges media information with the personal computer 2 on the basis of the control information exchanged by the control information communication module 217.

The service execution module 218 executes an exchange service such as voice dialing or the like that uses the media information communication path 4 on the basis of the media information exchanged by the media information communication module 217.

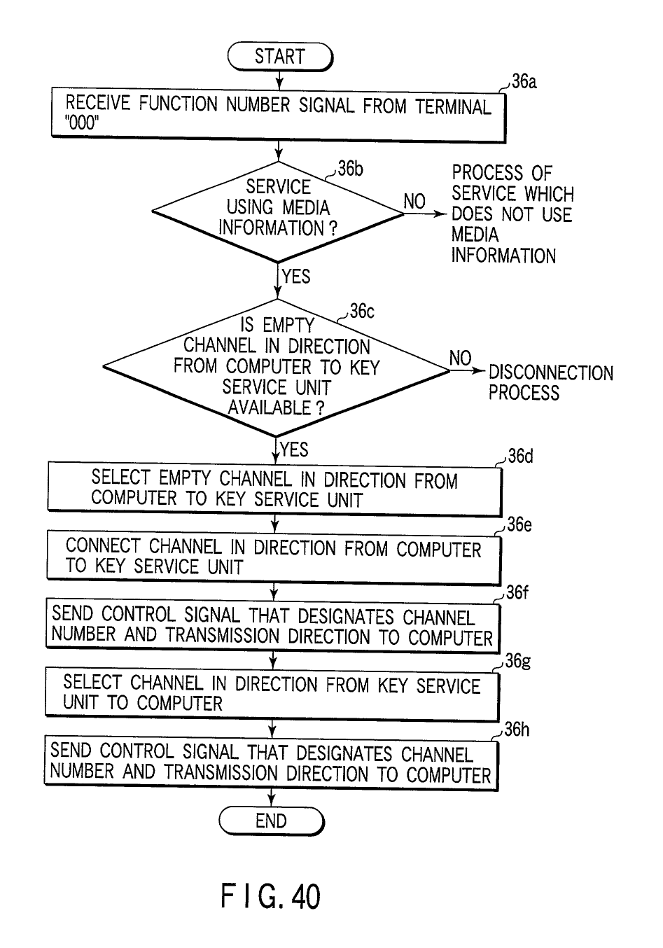

The operation of the system with the above arrangement will be explained below taking a voice dialing service as an example. FIG. 40 is a flow chart showing the control sequence and control contents by the main controller 11 of the key service unit 1.

Prior to the beginning of the operation of the system, the key service unit 1 executes a process for permanently assigning down channels of the media information communication path 4, which go from the key service unit 1 to the personal computer 2, to the telephone terminals 50 to 5n and data highway 12.

More specifically, the main controller 11 acquires from the table 161 down channel numbers (media bus output-side logical channel numbers) of the media information communication path 4 corresponding to the telephone terminals 50 to 5n and data highway 12, and obtains time switch output-side channel numbers corresponding to those logical channels from the storage contents of the table 134. The main controller 11 then permanently connects the obtained time switch output-side channels and time switch input-side channels corresponding to the telephone terminals 50 to 5n and data highway 12.

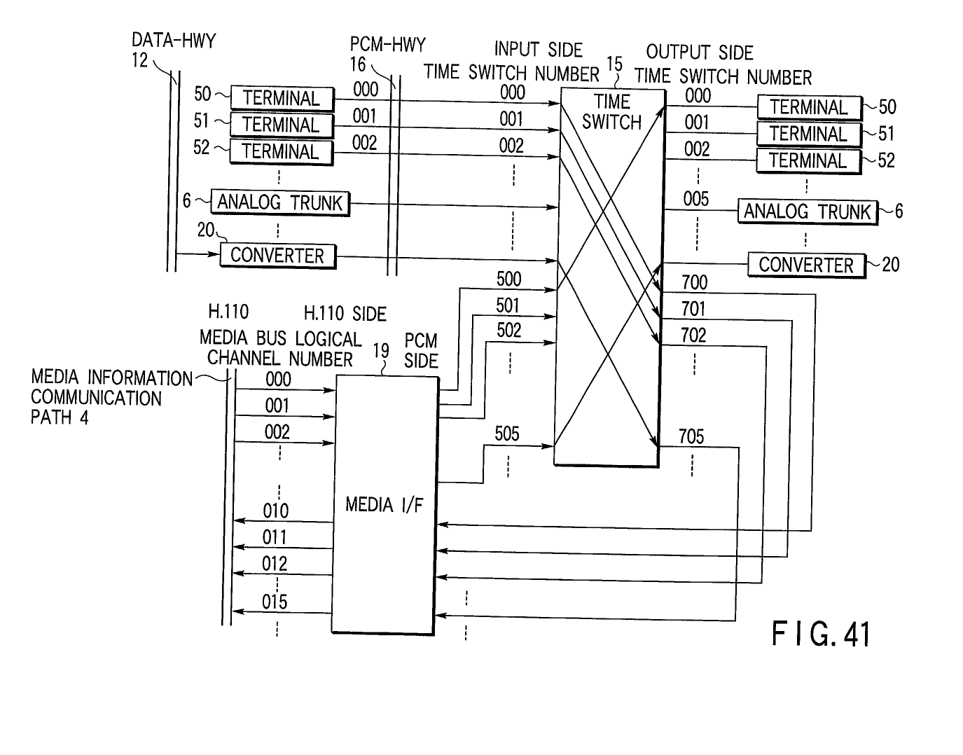

With this connection control, the telephone terminals 50 to 5n “000”, “001”, “002”, . . . are respectively permanently connected to time switch output-side channel numbers “700”, “701”, “702”, . . . corresponding to media bus logical channel numbers “010”, “011”, “012”, . . . . Also, the data highway 12 is permanently connected to time switch output-side channel number “705”, corresponding to media bus logical channel number “015”. FIG. 41 shows this connection state.

As a result of this permanent connection, the telephone terminals 50 to 5n are always connected to the down channels of the media information communication path 4, and media information output from each of the telephone terminals 50 to 5n can always be transferred onto the corresponding down channel of the media information communication path 4. Also, the data highway 12 is always connected to a down channel of the media information communication path 4, thus allowing to always transfer control information of the main controller 11 onto the down channel of the media information communication path 4.

Assume that the user of the telephone terminal 50 inputs a function number for executing a voice dialing function using a key-pad or function key (not shown) of the telephone terminal 50 after he or she picks up a handset in this state. A function number signal generated as a result of user's operation is detected by the extension interface circuit 17, and is sent to the main controller 11 via the data highway 12.

Upon detecting this offhook in step 36a, the flow advances to step 36b, and the main controller 11 checks based on the contents of the table 131 if the caller telephone terminal 50 requests an exchange service using media information. If the requested exchange service uses media information, the flow advances to step 36c. If it is determined that the requested exchange service is a normal service that does not use media information, a normal dialing process is executed.

The main controller 11 checks in step 36c based on the contents of the table 132 if an empty channel is available in the up channels of the media information communication path 4. If an empty channel is found, the flow advances to step 36d to select that empty channel, and the main controller 11 connects the selected empty channel to the caller telephone terminal 50 via the time switch 15 in accordance with the contents of the table 163 in step 36e.

For example, assume that media bus logical channel number “000” is selected as an empty channel. Since time switch input-side channel number “500” is registered in the table 163, as shown in FIG. 38, the main controller 11 controls the media I/F 19 to connect the up channel of media bus logical channel number “000” and time switch input-side channel number “500. The main controller 11 then controls the time switch 15 to connect the time switch input-side channel of number “500” and the time switch output-side channel of number “000” corresponding to the caller telephone terminal 50, as shown in FIG. 41.

As a result of checking in step 36c, if no empty channel is found, the main controller 11 outputs a busy tone signal to the caller telephone terminal 50, and when the user replaces the handset in response to that tone, a disconnection process is executed.

At the same time, the main controller 11 selects an empty up channel that can be used to transfer control information on the basis of the table 132, and connects the selected empty channel to the DATA-HWY converter 20 in step 36e. This connection is achieved by controlling the time switch 15 in accordance with the contents of the table 163.

Assume that media bus logical channel number “005” is selected as an empty channel. Since time switch input-side channel number “505” is registered in the table 163, as shown in FIG. 38, the main controller 11 controls the media I/F 19 to connect the up channel of media bus logical channel number “005” to time switch input-side channel number “505”. The main controller 11 then controls the time switch 15 to connect the time switch input-side channel with number “505” and a time switch output-side channel corresponding to the DATA-HWY converter 20, as shown in FIG. 41.

Subsequently, the main controller 11 selects media bus logical channel number “015” corresponding to the data highway 12 by looking up the table 161 in step 36f. At this time, the down channel “015” going from the key service unit 1 to the personal computer 2 has already been permanently assigned, as described above. Hence, by selecting the media bus logical channel number “015”, a control information transfer path extending from the main controller 11 to the personal computer 2 via the data highway 12, DATA-HWY converter 20, time switch 15, media I/F, and media information communication path 4 is assured.

After the control information transfer path is set, the main controller 11 generates control information that designates the selected media bus logical channel number “000” and its transmission direction (personal computer 2→key service unit 1), and outputs this control information onto the data highway 12. The control information is then converted into a PCM signal by the DATA-HWY converter 20, and the PCM signal is transferred to the media I/F via the time switch 15. The PCM signal is then transferred from the media I/F 19 to the personal computer 2 via the down channel “015” of the media information communication path 4.

Upon arrival of control information CD from the key service unit 1 via the control information transfer channel “015” on the media information communication path 4, the personal computer 2 receives that control information CD by the control information conversion board 27 to convert it into a format suitable for the internal bus 22, and the converted control information is sent to the main controller 21 via a control line I/F 27. The main controller 21 connects a speech synthesis board 26 to the up channel “000” designated by the received control information.

The speech synthesis board 26 generates voice guidance VG “State callee name aloud.”, and outputs this voice guidance VG onto the up channel of the designated media bus logical channel number “000” under the control of the main controller 21. This voice guidance VG is transferred to the media I/F 19 of the key service unit 1 via the designated up channel “000” of the media information communication path 4, and is then transferred from the media I/F 19 to the caller telephone terminal 50 via the time switch 15. Hence, the user of the telephone terminal 50 can know the next operation contents by this voice guidance VG.

The main controller 11 of the key service unit 1 selects media bus logical channel number “010” corresponding to the telephone terminal 50 “number 000” by looking up the table 161 in step 36g. At this time, a down channel from the key service unit 1 to the personal computer 2 has already been permanently assigned, as described above. For this reason, a media information transfer path extending from the caller telephone terminal 50 to the personal computer 2 via the time switch 15, media I/F 19, and the down channel of the media information communication path 4 is assured by selecting media bus logical channel number “010”.

The main controller 11 selects media bus logical channel number “015” corresponding to the data highway 12 by looking up the table 161 in step 36h. The main controller 11 generates control information that designates the media bus logical channel number “010” and its transmission direction (key service unit 1→personal computer 2), and outputs that control information onto the data highway 12 to transfer it to the personal computer 2. The control information is converted into a PCM signal by the DATA-HWY converter 20, and the PCM signal is transferred to the media I/F 19 via the time switch 15. The PCM signal is transferred from the media I/F 19 to the personal computer 2 via the down channel “015” on the media information communication path 4.

Upon arrival of control information CD from the key service unit 1 via the control information transfer channel “015” on the media information communication path 4, the personal computer 2 receives that control information CD by the control information conversion board 27 to convert it into a format suitable for the internal bus 22, and the converted control information is sent to the main controller 21 via the control line I/F 27. The main controller 21 connects a speech recognition board 25 to the up channel “010” designated by the received control information.

If the user of the telephone terminal 50 inputs the callee name “YAMAMOTO” by voice in accordance with the voice guidance VG in that state, a voice signal VD which represents the callee name “YAMAMOTO” is transferred from the telephone terminal 50 to the speech recognition board 25 of the personal computer 2 via the time switch 15, media I/F 19, and the down channel “010” of the media information communication path 4. The speech recognition board 25 generates a character string corresponding to the input voice signal VD using a voice-character string conversion table, and sends the character string to the main controller 21. The main controller 21 reads out a corresponding telephone number “5621” from the storage device 23 on the basis of the received character string “YAMAMOTO”. The main controller 21 then supplies control information containing this telephone number and a dialing control signal to the control information conversion board 27. The control information is converted into a PCM signal by the control information conversion board 27, and the PCM signal is output onto the up channel “005” for control signal transfer, which is set on the media information communication path 4.

Upon arrival of the control information from the personal computer 2 at the key service unit 1 via the up channel “005”, the control information is input from the media I/F 19 to the DATA-HWY converter 20 via the time switch 15, and is restored from the PCM signal to the original control information. This control information is transferred to the main controller 11 via the data highway 12. The main controller 11 of the key service unit 1 detects a dialing control signal contained in the transferred control information, and executes a dialing process to, e.g., a callee telephone terminal 51 on the basis of the telephone number sent together with the control signal. In this manner, voice dialing is performed.

As described above, according to the sixth embodiment, up and down channels used to transfer media information, and also a channel used to transfer control information are set on the media information communication path 4. Control information is exchanged between the key service unit 1 and personal computer 2 using the channel set on the media information communication path 4. Therefore, the need for the control information communication path 3 can be obviated, and the number of cables that connect the key service unit 1 and personal computer 2 can be decreased accordingly, thus simplifying the wiring structure of the system.

As for channels used to transfer control information, down channels are permanently set and up channels are dynamically set in the same manner as the channels used to transfer media information. Therefore, efficient channel setups can be done.

### Other Embodiments

In the first embodiment, upon activating an exchange service, only an up channel used to transfer media information is dynamically set. However, not only an up channel but also a down channel may be dynamically set. The same applies to the fifth embodiment in which the personal computer 2 sets channels used to transfer media information.

In the third embodiment, both up and down channels used to transfer media information are dynamically set when the operation state that requires media transfer has been reached during execution of an exchange service. However, either an up or down channel may be dynamically set.

In the sixth embodiment, upon setting channels used to transfer control information on the media information communication path 4, a down channel is permanently set, and an up channel is dynamically set. By contrast, an up channel may be permanently set, and a down channel may be dynamically set. Alternatively both up and down channels may be permanently or dynamically set.

In each of the above embodiments, a service execution sequence when an exchange service using the media information communication path 4 is activated by the key service unit 1 has been explained. Also, when an exchange service using the media information communication path 4 is activated by the personal computer 2, the service can be executed in the same sequence. Such case is effective for an Internet telephone or the like.

In each of the above embodiments, when an exchange service using the media information communication path 4 is activated, the key service unit 1 and personal computer 2 exchange control information via the control information communication path 3 to execute the service. Alternatively, depending on the service contents, the key service unit 1 and personal computer 2 may exchange media information via the media information communication path 4 to execute the service.

In addition, the arrangements of the key service unit and personal computer, the information transfer protocol on the media information communication path, the type of exchange system (the present invention is not limited to the key telephone system but may be applied to a PBX in addition), the type of computer (the present invention is not limited to the personal computer but may use a workstation, server, or the like), the service execution sequence, and the like may be variously modified without departing from the scope of the invention.

To recapitulate, according to the present invention, an exchange system which can implement an exchange process with high line accommodation capacity and reliability, can provide an exchange service using multimedia techniques, a telephone exchange apparatus, and a computer apparatus can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An exchange system which comprises a telephone exchange apparatus to which at least one terminal device is connected, and a computer apparatus having a processing function of media information, comprising:
a media information communication path which connects the telephone exchange apparatus and the computer apparatus, and has at least one media information channel pre-assigned to the terminal device;
media information communication means, in each of the telephone exchange apparatus and the computer apparatus, for communicating the media information between the telephone exchange apparatus and the computer apparatus via the media information channel of said media information communication path, when an execution request of a service associated with exchange using the media information is generated; and
service execution means for executing the service by the telephone exchange apparatus and the computer apparatus on the basis of the media information communicated by said media information communication means.

2. An exchange system which comprises a telephone exchange apparatus to which at least one terminal device is connected, and a computer apparatus having a processing function of media information, comprising:
a media information communication path which connects the telephone exchange apparatus and the computer apparatus, and has a plurality of media information channels;
channel selection means, in at least one of the telephone exchange apparatus and the computer apparatus, for selecting an empty media information channel from the plurality of media information channels, when an execution request of a service associated with exchange using the media information is generated;
media information communication means for communicating the media information between the telephone exchange apparatus and the computer apparatus via the media information channel selected by said channel selection means; and
service execution means for executing the service by the telephone exchange apparatus and the computer apparatus on the basis of the media information communicated by said media information communication means.

3. An exchange system which comprises a telephone exchange apparatus, and a computer apparatus having a processing function of media information, comprising:
a communication path which is comprised of a control information communication path for communicating control information, and a media information communication path for communicating the media information using a plurality of media information channels, and connects the telephone exchange apparatus and the computer apparatus;
channel selection means, in at least one of the telephone exchange apparatus and the computer apparatus, for communicating control information between the telephone exchange apparatus and the computer apparatus via the control information communication path, and selecting an empty media information channel from the plurality of media information channels in accordance with the control information communicated via the control information communication path, when an execution request of a service associated with exchange using the media information is generated;
media information communication means for communicating the media information between the telephone exchange apparatus and the computer apparatus via the media information channel selected by said channel selection means; and
service execution means for executing the service by the telephone exchange apparatus and the computer apparatus on the basis of the media information communicated by said media information communication means.

4. An exchange system which comprises a telephone exchange apparatus, and a computer apparatus having a processing function of media information, comprising:
a media information communication path which connects the telephone exchange apparatus and the computer apparatus;
determination means, in at least one of the telephone exchange apparatus and the computer apparatus, for checking if the service is associated with the computer apparatus, when an execution request of a service associated with exchange using the media information is generated;
media information communication means for communicating the media information between the telephone exchange apparatus and the computer apparatus via said media information communication path, when said determination means determines that the service is associated with the computer apparatus; and
service execution means for executing the service by the telephone exchange apparatus and the computer apparatus on the basis of the media information communicated by said media information communication means.

5. An exchange system which comprises a telephone exchange apparatus, and a computer apparatus having a processing function of media information, comprising:
a media information communication path which connects the telephone exchange apparatus and the computer apparatus;
communication means, in each of the telephone exchange apparatus and the computer apparatus, for communicating control information and the media information between the telephone exchange apparatus and the computer apparatus via said media information communication path, when a service request using the media information is generated; and
service execution means for executing the service by the telephone exchange apparatus and the computer apparatus on the basis of the control information and the media information communicated by said communication means.

6. An exchange system which comprises a telephone exchange apparatus to which at least one terminal device is connected, and a computer apparatus having a processing function of media information, comprising:
a media information communication path which connects the telephone exchange apparatus and the computer apparatus, and has at least one media information channel pre-assigned to the terminal device;
media information communication means, in each of the telephone exchange apparatus and the computer apparatus, for communicating the media information between the telephone exchange apparatus and the computer apparatus via the media information channel of said media information communication path, when an execution request of a service associated with exchange using the media information is generated;
first service execution means, in the telephone exchange apparatus, for executing a part of the service associated with said execution request, on the basis of the media information communicated by said media information communication means; and
second service execution means, in the computer apparatus, for executing another part of the service associated with said execution request, on the basis of the media information communicated by said media information communication means.

7. An exchange system which comprises a telephone exchange apparatus to which at least one terminal device is connected, and a computer apparatus having a processing function of media information, comprising:
a media information communication path which connects the telephone exchange apparatus and the computer apparatus, and has a plurality of media information channels;
channel selection means, in at least one of the telephone exchange apparatus and the computer apparatus, for selecting an empty media information channel from the plurality of media information channels;
media information communication means for communicating the media information between the telephone exchange apparatus and the computer apparatus via the media information channel selected by said channel selection means;
first service execution means, in the telephone exchange apparatus, for executing a part of the service associated with said execution request, on the basis of the media information communicated by said media information communication means; and
second service execution means, in the computer apparatus, for executing another part of the service associated with said execution request, on the basis of the media information communicated by said media information communication means.

8. An exchange system which comprises a telephone exchange apparatus, and a computer apparatus having a processing function of media information, comprising:
a communication path which is comprised of a control information communication path for communicating control information, and a media information communication path for communicating media information using a plurality of media information channels, and connects the telephone exchange apparatus and the computer apparatus;
channel selection means, in at least one of the telephone exchange apparatus and the computer apparatus, for communicating the control information between the telephone exchange apparatus and the computer apparatus via the control information communication path, and selecting an empty media information channel from the plurality of media information channels in accordance with the control information communicated via the control information communication path, when an execution request of a service associated with exchange using the media information is generated;
media information communication means for communicating the media information between the telephone exchange apparatus and the computer apparatus via the media information channel selected by said channel selection means; and
first service execution means, in the telephone exchange apparatus, for executing a part of the service associated with said execution request, on the basis of the media information communicated by said media information communication means; and
second service execution means, in the computer apparatus, for executing another part of the service associated with said execution request, on the basis of the media information communicated by said media information communication means.

9. An exchange system which comprises a telephone exchange apparatus, and a computer apparatus having a processing function of media information, comprising:
a media information communication path which connects the telephone exchange apparatus and the computer apparatus;
determination means, in at least one of the telephone exchange apparatus and the computer apparatus, for checking if the service is associated with the computer apparatus, when an execution request of a service associated with exchange using the media information is generated;
media information communication means for communicating the media information between the telephone exchange apparatus and the computer apparatus via said media information communication path, when said determination means determines that the service is associated with the computer apparatus;
first service execution means, in the telephone exchange apparatus, for executing a part of the service associated with said execution request, on the basis of the media information communicated by said media information communication means; and
second service execution means, in the computer apparatus, for executing another part of the service associated with said execution request, on the basis of the media information communicated by said media information communication means.

10. An exchange system which comprises a telephone exchange apparatus, and a computer apparatus having a processing function of media information, comprising:
a media information communication path which connects the telephone exchange apparatus and the computer apparatus;
communication means, in each of the telephone exchange apparatus and the computer apparatus, for communicating control information and the media information between the telephone exchange apparatus and the computer apparatus via said media information communication path, when an execution request of a service associated with exchange using the media information is generated;
first service execution means, in the telephone exchange apparatus, for executing a part of the service associated with said execution request, on the basis of the media information communicated by said communication means; and
second service execution means, in the computer apparatus, for executing another part of the service associated with said execution request, on the basis of the media information communicated by said communication means.

11. An exchange system according to any one of claims 6 to 10, wherein said first service execution means executes at least a dialing process including the service associated with said execution request, on the basis of the media information communicated by said media information communication means; and
said second service execution means executes a process, excluding said dialing process associated with said execution request, on the basis of the media information communicated by said media information communication means.

12. A telephone exchange apparatus which is connected to a computer apparatus having a processing function of media information via a media information communication path having a plurality of media information channels pre-assigned to a plurality of terminal devices, comprising:
media information communication means for communicating the media information with the computer apparatus via the media information channels, when an execution request of a service associated with exchange using the media information is generated; and
service execution means for executing at least a part of the service on the basis of the media information communicated by said media information communication means.

13. A telephone exchange apparatus which is connected to a computer apparatus having a processing function of media information via a media information communication path having a plurality of media information channels, comprising:
channel selection means for selecting an empty channel from the plurality of media information channels, when an execution request of a service associated with exchange of the media information is generated;
media information communication means for communicating the media information with the computer apparatus via the empty media information channel selected by said channel selection means; and
service execution means for executing at least a part of the service on the basis of the media information communicated by said media information communication means.

14. A telephone exchange apparatus which is connected to a computer apparatus having a processing function of media information via a control information communication path for communicating control information, and a media information communication path having a plurality of media information channels, comprising:
channel selection means for selecting an empty media information channel from the plurality of media information channels on the media information communication path, in accordance with the communicated control information to or from the computer apparatus via the control information communication path, when an execution request of a service associated with exchange of the media information is generated;
media information communication means for communicating the media information with the computer apparatus via the media information channel selected by said channel selection means; and
service execution means for executing at least a part of the service on the basis of the media information communicated by said media information communication means.

15. A telephone exchange apparatus which is connected to a computer apparatus having a processing function of media information via a media information communication path, comprising:
determination means for checking if the service is associated with the computer apparatus, when an execution request of a service associated with exchange of the media information is generated;
media information communication means for communicating the media information with the computer apparatus via the media information communication path, when said determination means determines that the service is associated with the computer apparatus; and
service execution means for executing at least a part of the service on the basis of the media information communicated by said media information communication means.

16. A telephone exchange apparatus which is connected to a computer apparatus having a processing which is function of media information via a media information communication path, comprising:
communication means for communicating control information and the media information with the computer apparatus via the media information communication path, when an execution request of a service associated with exchange of the media information is generated; and
service execution means for executing at least a part of the service on the basis of the control information and media information communicated by said communication means.

17. A computer apparatus which is connected to a telephone exchange apparatus, to which at least one terminal device is connected, via a media information communication path having a plurality of media information channels pre-assigned to the terminal device, comprising:
media information communication means for communicating the media information with the telephone exchange apparatus via the media information channels, when an execution request of a service associated with exchange using media information is generated; and
service execution means for executing at least a part of the service on the basis of the media information communicated by said media information communication means.

18. A computer apparatus which is connected to a telephone exchange apparatus, to which at least one terminal device is connected, via a media information communication path having a plurality of media information channels, comprising:
channel selection means for selecting an empty media information channel from the plurality of media information channels, when an execution request of a service associated with exchange using media information is generated,;
media information communication means for communicating the media information via the media information channel selected by said channel selection means; and
service execution means for executing at least a part of the service on the basis of the media communicated received by said media information communication means.

19. A computer apparatus which is connected to a telephone exchange apparatus, to which at least one terminal device is connected, via a control information communication path for transmitting control information, and a media information communication path having a plurality of media information channels, comprising:
channel selection means for selecting an empty media information channel from the plurality of media information channels on the media information communication path in accordance with communicating control information to or from the telephone exchange apparatus via the control information communication path, when an execution request of a service associated with exchange using media information is generated,;
media information communication means for communicating the media information with the telephone exchange apparatus via the media information channel selected by said channel selection means; and
service execution means for executing at least a part of the service on the basis of the media information communicated by said media information communication means.

20. A computer apparatus which is connected to a telephone exchange apparatus, to which at least one terminal device is connected, via a media information communication path, comprising:
determination means for checking if the service is associated with the self apparatus, when an execution request of a service associated with exchange using media information is generated;
media information communication means for communicating the media information with the telephone exchange apparatus via the media information communication path, when said determination means determines that the service is associated with the self apparatus; and
service execution means for executing at least a part of the service on the basis of the media information communicated by said media information communication means.

21. A computer apparatus which is connected to a telephone exchange apparatus, to which at least one terminal device is connected, via a media information communication path, comprising:
communication means for communicating control information and media information with the telephone exchange apparatus via the media information communication path, when an execution request of a service associated with exchange using media information is generated; and
service execution means for executing at least a part of the service on the basis of the control information and the media information communicated by said communication means.

22. An exchange system which comprises a telephone exchange apparatus to which at least one terminal device is connected, and a computer apparatus having a processing function of media information, comprising:
a media information communication path which connects the telephone exchange apparatus and the computer apparatus, and has at least one media information channel pre-assigned to the terminal device;
media information communicator in each of the telephone exchange apparatus and the computer apparatus, for, communicating the media information between the telephone exchange apparatus and the computer apparatus via the media information channel of said media information communication path, when an execution request of a service associated with exchange using the media information is generated; and
service executer for executing the service by the telephone exchange apparatus and the computer apparatus on the basis of the media information communicated by said media information communicator.

23. An exchange system which comprises a telephone exchange apparatus to which at least one terminal device is connected, and a computer apparatus having a processing function of media information, comprising:
a media information communication path which connects the telephone exchange apparatus and the computer apparatus, and has a plurality of media information channels;
channel selector, in at least one of the telephone exchange apparatus and the computer apparatus, for, selecting an empty media information channel from the plurality of media information channels, when an execution request of a service associated with exchange using the media information is generated;
media information communicator for communicating the media information between the telephone exchange apparatus and the computer apparatus via the media information channel selected by said channel selector; and
service executer for executing the service by the telephone exchange apparatus and the computer apparatus on the basis of the media information communicated by said media information communicator.

24. An exchange system which comprises a telephone exchange apparatus, and a computer apparatus having a processing function of media information, comprising:
a communication path which is comprised of a control information communication path for communicating control information, and a media information communication path for communicating the media information using a plurality of media information channels, and connects the telephone exchange apparatus and the computer apparatus;
channel selector, in at least one of the telephone exchange apparatus and the computer apparatus, for communicating control information between the telephone exchange apparatus and the computer apparatus via the control information communication path, when an execution request of a service associated with exchange using the media information is generated, and selecting an empty media information channel from the plurality of media information channels in accordance with the control information communicated via the control information communication path;
media information communicator for communicating the media information between the telephone exchange apparatus and the computer apparatus via the media information channel selected by said channel selector; and
service executer for executing the service by the telephone exchange apparatus and the computer apparatus on the basis of the media information communicated by said media information communicator.

25. An exchange system which comprises a telephone exchange apparatus, and a computer apparatus having a processing function of media information, comprising:
a media information communication path which connects the telephone exchange apparatus and the computer apparatus;
determinater, in at least one of the telephone exchange apparatus and the computer apparatus, for checking if the service is associated with the computer apparatus, when an execution request of a service associated with exchange using the media information is generated;
media information communicator for communicating the media information between the telephone exchange apparatus and the computer apparatus via said media information communication path, when said determinater determines that the service is associated with the computer apparatus; and
service executer for executing the service by the telephone exchange apparatus and the computer apparatus on the basis of the media information communicated by said media information communicator.

26. An exchange system which comprises a telephone exchange apparatus, and a computer apparatus having a processing function of media information, comprising:
a media information communication path which connects the telephone exchange apparatus and the computer apparatus;
communicator, in each of the telephone exchange apparatus and the computer apparatus, for communicating control information and the media information between the telephone exchange apparatus and the computer apparatus via said media information communication path, when a service request using the media information is generated; and
service executer for executing the service by the telephone exchange apparatus and the computer apparatus on the basis of the control information and the media information communicated by said communicator.

27. An exchange system which comprises a telephone exchange apparatus to which a plurality of terminal devices are connected, and a computer apparatus, comprising:
a media information communication path for connecting the telephone exchange apparatus and the computer apparatus;
transfer means of the telephone exchange apparatus for transferring the voice signal to the computer apparatus via said media information communication path, when a voice signal is sent from one of the plurality of terminal devices;
speech recognition means of the computer apparatus for recognizing contents of the voice signal transferred by said transfer means; and
dialing means of the telephone exchange apparatus for executing a dialing process to another terminal device on the basis of a speech recognition result.

28. A telephone exchange apparatus which is connected to a computer apparatus having a speech recognition function via a media information communication path, and to which a plurality of terminal devices are connected, comprising:
transfer means for transferring the voice signal to the computer apparatus via the media information communication path, when a voice signal is sent from one of the plurality of terminal devices; and
dialing means for executing a dialing process to another terminal device on the basis of a speech recognition result of the computer apparatus.

29. A computer apparatus which is connected to a telephone exchange apparatus, to which a plurality of terminal devices are connected, via a media information communication path, comprising:
speech recognition means for recognizing contents of the voice signal, when a voice signal comes from the telephone exchange apparatus via the media information communication path; and
transfer means for transferring a speech recognition result of said speech recognition means to the telephone exchange apparatus via the media information communication path, and making the telephone exchange apparatus execute a dialing process to another terminal device.
